(19) United States
(12) Patent Application Publication
(10) Pub. No.: US 2008/0114519 A1
(43) Pub. Date: May 15, 2008

(54) Automatically and remotely controlled brake actuator systems

(76) Inventors: Douglas P. DuFaux, Orchard Park, NY (US); Matthew Geise, Lockport, NY (US)

Correspondence Address: Carol H. Peters;Mintz, Levin, Cohn, Ferris,, Glovsky and Popeo, P.C., One Financial Center, Boston, MA, 02111, US

(21) Appl. No.: 11/809,498

(22) Filed: Jun. 1, 2007

Related U.S. Application Data
(60) Provisional application No. 60/803,722, filed on Jun. 2, 2006.
(60) Provisional application No. 60/893,870, filed on Mar. 8, 2007.

(51) Int. Cl. B62L 5/18

(52) U.S. Cl. 701/70

(57) ABSTRACT

A remotely controlled brake actuator system for use with a wheeled vehicle includes a remote wireless transmitter, a wireless receiving and control unit to receive signals from the wireless transmitter, a vehicle-mounted braking arrangement, and an electronic controller operative to process signals the wireless receiver receives and to deliver electrical signals to the braking arrangement. The system also may be configured to implement a method to set a security code in the transmitter and the receiver in order the signals generated are specific to a particular wheeled vehicle. The system may further include a braking force/pressure adjustment selector switch for setting a force/pressure of braking pressure or force applied to a vehicle's braking mechanism. The system also may include a mode selection switch for selecting any one of various forms of braking force/pressure, such as intermittent or continuous applications, and/or for selecting or setting audible and/or visual warnings that braking action is imminent or in progress.

### PRIOR RELATED PATENT APPLICATIONS

This application claims priority to U.S. provisional patent Application Ser. No. 60/803,722, filed Jun. 2, 2006, and U.S. provisional Application Ser. No. 60/893,870, filed Mar. 8, 2007, each of the disclosures of which is incorporated herein in its entirety by reference.

### FIELD OF THE INVENTION

The invention relates to a brake actuator system for use with a wheeled vehicle, and more particularly to a wireless brake actuator system for remotely controlling a bicycle braking system and that may additionally provide automatic control of the bicycle braking system.

### BACKGROUND OF THE INVENTION

Numerous operator-actuated brake systems for wheeled vehicles are available including, for instance, braking systems for bicycles, tricycles, toy vehicles for children, and various sporting goods. Many types of bicycle braking systems use a mechanical system to transfer pressure applied by an operator's hand on a pivoting mechanism on the bicycle handlebars to a mechanism that applies force to rubber or plastic pads that provide resistance on the rim of a wheel, thus forcing the bicycle to slow or to stop. More recent bicycle braking systems are similar to disc brakes on an automobile or motorcycle. The operator may still use a hand mechanism mounted on the handlebars to apply a force, but under this design, the force is transferred to a hydraulic or mechanical unit that forces pressure to be applied to pads which causes resistance to a disc that is connected to a wheel. The resistance slows or stops the progress of the bicycle. Other brake systems are totally hydraulically actuated and controlled.

Often it is desirable to provide a braking system on a vehicle, such as a bicycle or tricycle that may be actuated by an operator riding the vehicle while at the same time allowing the brakes to be controlled from a position remote from the bicycle. For instance, a parent may desire to stop or to retard the progress of a child riding a bicycle or tricycle to prevent an accident or to put a range limitation on a child's vehicle for safety purposes or to achieve other reasons for restricting or controlling a child riding a bicycle or tricycle.

### SUMMARY OF THE INVENTION

It is desirable to employ the braking mechanism of a wheeled vehicle, such as a bicycle, to control or limit the progress of such a vehicle from a remote or separate location rather than using a separate braking system to achieve remote control of the vehicle. Use of the vehicle's own braking mechanism for remote, and additionally automatic, control of the vehicle is advantageous and enables a person riding the vehicle to also actuate the vehicle's braking mechanism. For many children's bicycles and tricycles, petal brakes are typical the braking mechanism employed, such as rear wheel petal brakes, a separate braking mechanism, such as a caliper type braking mechanism, may be installed on a rear brake to enable remote, and additionally automatic, control of the braking mechanism.

An object of the invention provides a unique, remotely controlled brake actuator system for use with braking systems or mechanisms of wheeled vehicles and, more particularly, for use, for instance, with bicycles, tricycles, and other wheeled vehicles.

It is a further object of the invention to provide a brake actuator system to automatically control brake systems or mechanisms of wheeled vehicles and, more particularly, for use, for instance with bicycles, tricycles, and other wheeled vehicles.

It is another object of the invention to provide a remotely controlled brake actuator system for wheeled vehicles that operates without detracting from the effectiveness of the operator actuated braking system or mechanism of the vehicle.

It is a further object of the invention to provide remotely controlled brake actuator system for electrically, engine, or manually powered children's wheeled vehicles.

It is a further object of the invention to provide a remotely controlled brake actuator system for wheeled vehicles, including children's wheeled toys, roller skates, skate boards, and other sporting goods for use in emergency situations where the safety of an operator of the vehicle is in jeopardy.

It is a further object of the invention to provide a remotely controlled brake system for vehicles including roller skates, roller blades, skate boards and other wheeled sports equipment that allow an operator to control braking action though a wired or wireless control device.

A further object of the invention is to provide an automatically or remotely controlled braking system for a wheeled vehicle that is easily installed and that utilizes a portion or all of the existing brake system, mechanism, rigging, and/or equipment of the vehicle.

A further object of the invention is to provide an automatically or remotely controlled braking system that provides for graduated application and release of a wheeled vehicle's brake system or mechanism.

In general, in an aspect, the invention provides a remotely controlled braking actuator system for use with a braking mechanism of a wheeled vehicle, the system comprising a transmitter configured for wireless communication and further configured for actuation in response to one or more actuation signals and a receiving and control unit operatively coupled with the transmitter and configured for wireless communication with the transmitter, the receiving and control unit being disposed remotely from the transmitter and mounted to the vehicle and being configured to respond to one or more control signals received from the transmitter. The system includes a braking arrangement operatively coupled with the receiving and control unit and mounted to the vehicle. The braking arrangement is disposed and being configured to implement a braking action of the braking mechanism of the vehicle, wherein in response to one or more signals the receiving and control unit provides to the braking arrangement, the braking arrangement implements a braking action of the vehicle braking mechanism to slow or to stop the vehicle.

Implementation of the invention may include one or more of the following features and/or advantages. The system further includes a switch disposed along the transmitter and operatively coupled with control electronics of the transmitter. The switch is configured to provide, when activated, the one or more actuation signals to the transmitter. The one or more actuation signals emanate from a source external to the system, and wherein the source defines a boundary or a perimeter within which the vehicle is permitted to operate. The transmitter is configured for automatic actuation upon receipt of the one or more actuation signals which the source automatically transmits to the transmitter in response to detection of operation of the vehicle outside of the boundary or perimeter. The transmitter further includes a security code setting unit programmed to set a security code value for enabling secure wireless communication to the receiving and control unit, and the receiving and control unit includes a processor programmed to determine whether the security code value received from the transmitter matches the set security code value or a stored security code value.

Implementation of the invention also may include one or more of the following features and/or advantages. The transmitter is configured with a braking force adjustment selector operatively coupled with control electronics of the transmitter, and the braking force adjustment selector is configured to set a level of force or pressure of the braking action. The receiving and control unit is programmed to provide one or more signals to the braking arrangement to implement the level of force or pressure of the braking action, if the security code value received matches the set security code value or a stored security code value. The transmitter is configured with a braking action form selector operatively coupled with control electronics of the transmitter, and the braking action form selector is configured to set a form of braking action the braking arrangement implements, wherein the form of braking action includes at least one of: impulse, intermittent, and continuous braking action. The processor of the receiving and control unit is programmed to provide one or more signals to the braking arrangement to implement the form of braking action, if the security code value received matches the set security code value or a stored security code value. The transmitter is configured with a form function switch operatively coupled with control electronics of the transmitter to set the processor to signal the braking arrangement to implement the form of braking action for a period of wireless transmission time. The transmitter is further configured with a second form function switch operatively coupled with control electronics of the transmitter to set the processor to signal the braking arrangement to implement the form of braking action for a period of time. The transmitter and the receiving and control unit are configured to operate wireless communication with a frequency range of from about 50 MHz to about 800 MHz.

Implementation of the invention may further include one or more of the following features and/or advantages. The braking arrangement includes an actuator operatively coupled with the processor of the receiving and control unit, and the actuator is disposed and being configured to implement the braking action in response to receiving one or more signals from the processor. The actuator includes any one of: (i) a spring-actuated actuator, (ii) a pneumatically-actuated actuator, and (iii) an electrical motor-actuated actuator. The braking action includes the actuator implementing the application of a force or tension to a tensioning wire of the vehicle braking mechanism. The actuator includes a linear actuator disposed and configured to generate a substantially linear force or tension, and wherein a linear translation component operatively connected with the linear actuator applies the linear force or tension to the tensioning wire. The braking arrangement includes a gear motor with a drive shaft mechanism operatively coupled to the processor of the receiving and control unit, the gear motor with the drive shaft mechanism being disposed and being configured to implement the braking action in response to receiving one or more signals received from the processor.

In another aspect, the invention provides a remotely controlled, motorized braking actuator system for use with a braking mechanism of a wheeled vehicle, the system comprising a transmitter configured for wireless communication and further configured for actuation in response to one or more actuation signals and a receiving and control unit operatively coupled with the transmitter and configured for wireless communication with the transmitter, the receiving and control unit being disposed remotely from the transmitter and mounted to the vehicle. The system further includes a processor disposed within the receiving and control unit and programmed to respond to one or more control signals received from the transmitter and a motor driver disposed within the receiving and control unit and operatively coupled with the processor. The motor is operatively coupled with the processor and the motor driver, the motor being disposed and being configured to cause a braking action of the braking mechanism of the vehicle, wherein in response to one or more signals the processor provides to the motor driver, the motor driver powers the motor to implement a braking action of the vehicle braking mechanism to slow or to stop the vehicle.

Implementation of the invention may include one or more of the following features and/or advantages. The one or more actuation signals emanate from a source external to the system, and wherein the source defines a boundary or a perimeter within which the vehicle is permitted to operate. The transmitter is configured for automatic actuation upon receipt of the one or more actuation signals which the source automatically transmits to the transmitter in response to detection of operation of the vehicle outside of the boundary or perimeter. The transmitter further includes a security code setting unit programmed to set a security code value for enabling secure wireless communication to the receiving and control unit, and the processor is programmed to determine whether the security code value received from the transmitter matches the set security code value or a stored security code value. The transmitter is configured with a braking force adjustment selector operatively coupled with control electronics of the transmitter, and the braking force adjustment selector is configured to set a level of force or pressure of the braking action. The processor is programmed to provide one or more signals to the braking arrangement to implement the level of force or pressure of the braking action, if the security code value received matches the set security code value or a stored security code value. The transmitter is configured with a braking action form selector operatively coupled with control electronics of the transmitter, and the braking action form selector is configured to set a form of braking action the braking arrangement implements, wherein the form of braking action includes at least one of: impulse, intermittent, and continuous braking action. The processor is programmed to provide one or more signals to the braking arrangement to implement the form of braking action, if the security code value received matches the set security code value or a stored security code value. The braking action of the vehicle braking mechanism the motor implements includes the motor causing the tightening of a cable operatively connected to the motor that applies a force or tension to the vehicle braking mechanism.

The above and other objects of the invention may be accomplished by a remotely activated brake actuator system having a remote wireless transmitter, a wireless receiver to receive a signal from the wireless transmitter, a vehicle mounted braking arrangement, and an electronic controller operative to process a signal received from the wireless receiver and deliver an electrical signal to the electronically controlled braking arrangement. The braking arrangement may be disposed between an operator actuated tensioning arrangement and a tension controlled braking mechanism, such that existing braking equipment of a vehicle is used.

The system may be configured to implement a method to set a security code, such as a security number, in the transmitter and receiver. The system may also include a braking force/pressure adjustment selector switch for setting the braking force/pressure of braking pressure or force to be applied to the vehicle, and/or a mode selection switch for selecting any one of intermittent, continuous, or other forms to apply braking pressure or force to the vehicle braking system or mechanism, or to illuminate or activate a warning system that braking action is imminent or in progress.

A remotely controlled brake system may be provided and is adapted to control the brakes of a bicycle and to operate in parallel with an operator actuated brake control. The brakes of the vehicle include wire tension controlled brakes with an operator controlled tension input arrangement operative to direct a tension force along a control wire to tension controlled brakes for actuation of such brakes.

The wireless communication of the brake system may be achieved with a system having a transmitter for transmitting a command signal of a remote operator supervising or otherwise guarding an operator of a vehicle, in the form of a radio or other suitable wireless signal, through a transmitting antenna, and a receiver affixed to the vehicle for receiving the radio signal transmitted by the transmitter through a receiving antenna. The received command signal is processed by the control electronics of the system to deliver a control command to apply a braking force to the vehicle.

In an aspect, the invention provides a remotely controlled brake actuator system including a vehicle mounted braking arrangement including a spring, a spring retainer/release mechanism, and mounting/connecting arrangement disposed between the operator actuated tensioning or pressurizing arrangement and the tension or pressure controlled braking mechanism. The spring retainer/release mechanism is preferably an electrically actuated system, such as a solenoid, that may be actuated by electrical power to release the spring thus imparting a tension force on the brake control line.

As an alternative, the braking arrangement may be an electrically controlled tension or pressure control arrangement disposed between the operator actuated tensioning or pressurizing arrangement and the tension or pressure controlled braking mechanism. The invention further provides for other alternatives to the tension or pressure controlled braking mechanism to enable use of the invention with a variety of braking designs and equipment.

In a further aspect, the invention provides a remotely controlled brake actuator system including a vehicle mounted braking arrangement including an electric motor to create the desired tension in the brake tensioning wire. The electric motor is connected to an electric power source, such as a common Ni—Cd battery or battery pack, though electrical wiring and circuits. By control of a transmitter and receiver, the electric motor is started and rotates the motor shaft, moving a directly or indirectly coupled linear translation device. The linear translation device is connected to a common bicycle brake cable, which in turn is connected to a standard caliper brake mounted to apply brake force to the rear wheel. When the motor is caused to rotate in a direction (i.e., either clockwise or counter clockwise), the linear translation device causes a tension in the brake cable, which causes the caliper brake to engage. When the motor is caused to rotate in the opposite direction, the tension is reduced and the braking action is reduced correspondingly.

The system according to the invention may be actuated by a remote operator that initiates braking and optionally the braking force/pressure of braking action through the remote transmitter which sends an electronic braking signal preferably by radio frequency wireless communication to the controller on the vehicle, thereby causing one or both wheels to brake. The electronic signal from the remote unit corresponds to the amount of desired braking action, which is then applied to the braking mechanism, and the amount of braking pressure is a function of that selected value. The braking force/pressure of braking action imparted on the braking system by the remote user may be selected in a variety of ways. For instance, the remote unit may include a braking force/pressure control as well as an actuator switch, such that the unit sends a signal to the equipped vehicle instructing the braking system to apply the selected braking action. Alternatively, in another instance, the amount of braking action may be controlled directly by providing a constant electronic transmission of the desired braking force/pressure from the remote unit to the equipped vehicle, which corresponds to the selected braking force/pressure on the remote unit; if the selected value is zero, then no transmission would be required and the default, or no transmission braking force/pressure of the equipped vehicle would be no braking action.

Other objects, features and advantages of the invention will be apparent from the following detailed disclosure, taken in conjunction with the accompanying sheets drawings, as well as the appended claims.

### BRIEF DESCRIPTION OF THE DRAWINGS

FIG. 1 is an elevation view of a prior art bicycle;

FIG. 2 is a plan view of a handlebar and a neck of a prior art bicycle;

FIG. 3 is a front view of a prior art tension wire-actuated caliper style brake mechanism;

FIG. 4 is a perspective view of a remotely controlled brake actuator system according to an aspect of the invention;

FIG. 5 is a functional block diagram of a transmitter of the system shown in FIG. 4;

FIG. 6 is a functional block diagram of a receiver of the system shown in FIG. 4;

FIG. 7 is a perspective view of a remotely controlled brake actuator system according to another aspect of the invention;

FIG. 8 is a functional block diagram of the transmitter of the system shown in FIG. 7;

FIGS. 9A-9C are perspective views of various transmitter designs for use with the system shown in FIG. 4 or FIG. 7;

FIG. 10 is an elevation view of the prior art bicycle of FIG. 1 illustrating a location of an installation of a remotely controlled, vehicle-mounted wireless receiver and braking arrangement of the system shown in FIG. 4 or FIG. 7;

FIG. 11 is an elevation view of a spring actuated braking arrangement of the system shown in FIG. 4 or FIG. 7;

FIG. 12 is an elevation view of a pneumatic piston actuated braking arrangement of the system shown in FIG. 4 or in FIG. 7;

FIG. 13 is an elevation view of an alternative location of a pneumatic piston for the braking arrangement of the system shown in FIG. 4 or in FIG. 7;

FIG. 14 is an elevation view of an electric motor actuated braking arrangement of the system shown in FIG. 4 or in FIG. 7;

FIG. 15 is a perspective view of a remotely controlled, vehicle amounted brake actuator system of a further aspect of the invention;

FIG. 16 is a functional block diagram of the transmitter shown in FIG. 15;

FIG. 17 is a cut-away view of the vehicle mounted receiver and braking arrangement of the system shown in FIG. 15

FIG. 18 is a functional block diagram of the vehicle mounted receiver and braking arrangement shown in FIG. 15;

FIG. 19 is a front view of a tension wire-actuated caliper style brake mechanism including a cable attachment allowing the caliper brake to be actuated via separate cables; and

FIG. 20 is a front view of a drive shaft-actuated caliper-style brake mechanism including a gear motor directly coupled to a caliper brake via a threaded rod.

### DETAILED DESCRIPTION OF THE INVENTION

Illustrative embodiments of the invention are described in detail below with reference to the accompanying drawings, where like numerals represent like components. The invention provides a remotely activated brake actuator system for use with a wheeled vehicle having a remote wireless transmitter, a wireless receiving and control unit to receive a signal from the wireless transmitter, a vehicle-mounted braking arrangement, and an electronic controller operative to process a signal received from the wireless receiver and to deliver an electrical signal to the electronically controlled braking arrangement. The system also may be configured to implement a method to set a security code, e.g., a security number, in the transmitter and receiver. The system may further include a braking force/pressure adjustment selector switch for setting the braking force/pressure of braking pressure or force to be applied to a vehicle. The system also may include a mode selection switch or actuator for selecting any one of intermittent, continuous, or other forms to apply braking force/pressure to a vehicle or to illuminate or activate a warning system that braking action is imminent or in progress. Other embodiments fall within the scope and spirit of the invention.

For purposes of disclosure only, the brake actuator system according to the invention is described below in the context of a bicycle, although the invention is not so limited and envisions the system may be incorporated with any of a variety of wheeled vehicles, including, but not limited to, bicycles, tricycles, children's wheeled vehicles, children's wheeled toys, scooters, mopeds, go-carts, roller skates, roller blades, skate boards, and other wheeled sports equipment.

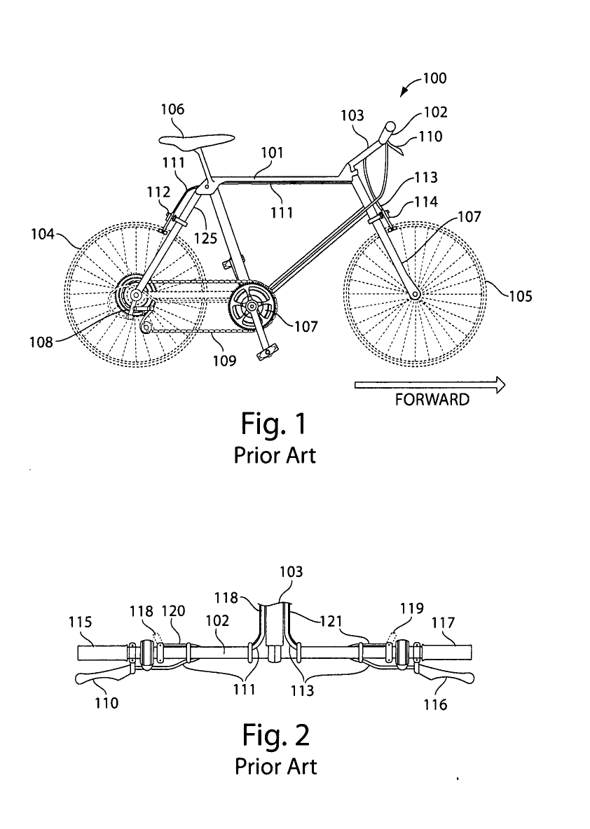

Referring to FIGS. 1-3, a typical prior art bicycle 100 is illustrated including a tension wire braking mechanism well known in the prior art. A bicycle frame 101 supports other components including handlebar 102, which is connected to the frame 101 via stem 103, rear wheel 104, front wheel 105, seat 106, and drive sprocket 107 connected to the wheel mounted sprocket 108 by a chain or belt 109. Rear frame post 125 is connected to the frame 101 and supports the braking device 112. The bicycle braking system includes both a front and rear braking mechanism, typically operating completely independent of each other. However, some bicycles, especially children's bicycles, only include a rear braking system. Furthermore, some bicycles utilize pedal actuated brakes, but may be retrofitted to included tension-wire or hydraulically actuated brakes.

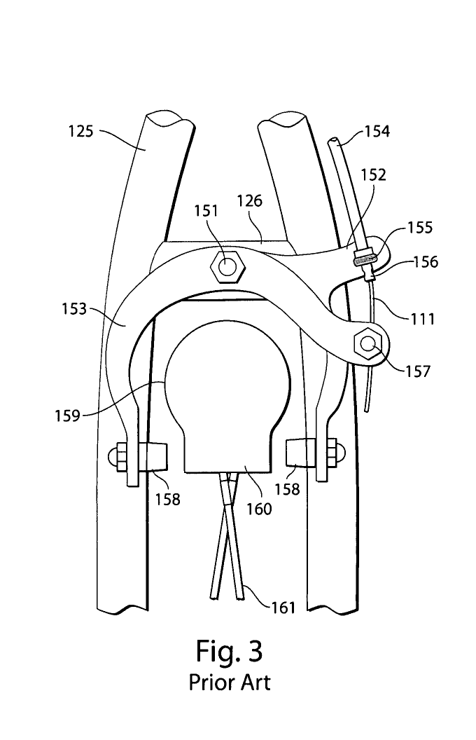

As shown in FIG. 1, the front and rear brake mechanisms are comprised of three key components, a hand-activated brake actuation mechanism, a wire cable, optionally protected at selected locations by a protective sheath, and a device 112, such as a caliper type braking mechanism as shown in FIG. 3, to transfer braking action to the wheel. A hand operated rear brake lever 110 is mounted to the handlebar 102 and connected through brake cable 111 to the rear braking device 112. Front brake lever (not shown) is connected through brake cable 113 to the front braking device 114.

As shown in FIG. 2, a top view of the handlebar 102 and stem 103 of the prior art bicycle shown in FIG. 1 is illustrated. Rear brake lever 110 is commonly mounted to the right side of the handlebar 102 and connected to a brake cable 111 such that a tension in the cable 111 is produced as the lever 110 is squeezed towards the right grip 115 of the handlebar 102. Front brake lever 116 is mounted to the left side of the handlebar 102 and connected to brake cable 113 such that a tension in the cable 113 is produced as the lever 116 is squeezed towards the left grip 117 of the handlebar 102. Also shown in FIG. 2 are typical gear-shifting mechanisms 118 and 119. The right side gearshift mechanism 118 is connected to frame mounted equipment via cable 120 and left side gearshift mechanism 119 is connected to frame mounted equipment via cable 121.

As shown in FIG. 3, one type of caliper-style braking device or assembly 112 of the prior art is shown. Various types and designs of caliper braking devices, such as pinch-type, as well as various other types and installations, are known and many operate in a similar manner, e.g., are tension wire controlled. The caliper brake 112 is attached to the rear cross member 126 with a bolt 151. The cross member 126 is supported by the rear frame post 125. The caliper brake assembly 112 shown in FIG. 3 consists of two calipers 152 and 153 which are attached by the common bolt 151 passing through them. At the top end of caliper 152 the brake cable sheath 154 is held in place by a brake cable positioner 155 and a tightening mechanism 156. The brake cable 111 passes through the cable positioner 155 and connected to an arm of the second caliper 153 by a fastener screw 157. At the ends of each caliper are brake pads 158 which do not touch the bicycle tire 159 (shown as cut away view) but are positioned a short distance away from the bicycle tire rim 160 (shown as cut away view). Also shown are the spokes of the rim 161.

During braking, the brake cable 111 connected to the arm of caliper 153 has an applied tension transferred from a braking handle or another tensioning device. The increase in tension pulls the arm of caliper 153 towards the arm of caliper 152. The movement of the calipers then moves both brake pads 158 towards the tire rim 160 by rotating around the bolt 151 holding them to the frame 126. When the brake pads move together and put friction on the tire rim, the bicycle tire slows or stops based on the amount of tension exerted on the brake cable 111.

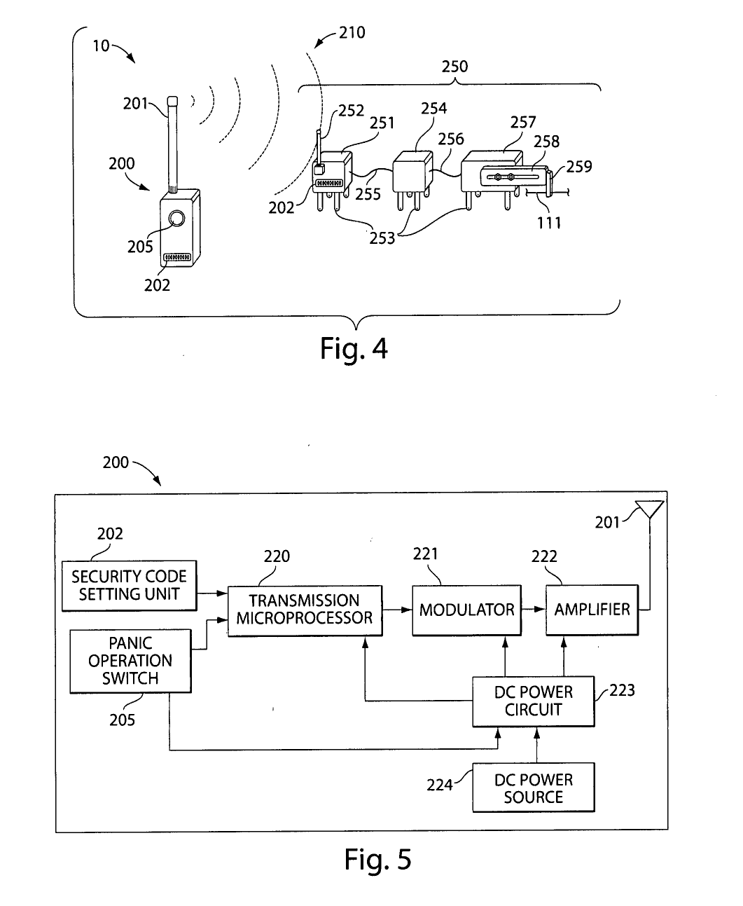

Referring to FIG. 4, and with further reference to FIGS. 1-3, in an aspect, the invention provides a remotely controlled brake actuator system 10 including a transmitter 200 and a receiving and control unit 250 configured and coupled for wireless communication. The transmitter 200 is configured for generating and transmitting wirelessly command and/or control signals in the form of radio signals through a transmitting antenna 201 to the receiving and control unit 250, which is mounted remotely from the transmitter 200 on a bicycle, e.g., through mounting straps 253, and is configured for receiving wirelessly radio signals transmitted by the transmitter 200. The transmitter 200 generates and transmits command and/or control signals to the receiving and control unit 250 in response to its actuation by, for instance, a person, e.g., a parent, supervisor or other guardian of an operator of the bicycle, who operates the transmitter 200. As will be described below, the transmitter 200 may be actuated to generate and transmit command and/or control signals through other devices and/or methods that generate and provide actuation inputs and/or signals to the transmitter 200 to actuate the transmitter 200 for operation.

The receiving and control unit 250 includes a receiver 251 with a receiving antenna 252 configured for receiving signals 210 transmitted wirelessly from the transmitter 200. The receiving and control unit 250 is configured to process information the received signal(s) 210 provide, to generate instruction commands, and to apply predetermined pressures, tension, and/or other control mechanisms to a braking system of the bicycle to which it is attached.

The receiving and control unit 250 also includes a power supply (not shown) and control electronics unit 254 that may be directly coupled to or integrated into the receiver 251, if desired or required. The receiver 251, power supply and the control electronics unit 254 are coupled through control wires 255. An energy supply and the control electronics unit 254 provide control signals through control wires 256 to an actuation unit 257. In conjunction with the control electronics unit 254, the actuation unit 257 converts energy stored in an energy supply, e.g., single-use batteries, rechargeable batteries, compressed gas, liquefied gas, high capacity capacitors, or any other form of energy, to a force that is imparted on a brake tensioning wire 111 of a bicycle 100 as shown in FIG. 1.

As illustrated in FIG. 4, energy from an energy supply and the control electronics unit 254 may be converted to a force, e.g., a linear force, through an actuator 257, e.g., a linear actuator, an electrically powered linear solenoid type device or other device. The actuator 257 is capable of generating a force that may be converted, e.g., to a substantially linear direction, and applied to a translation component 258, e.g., a linear translation component, and the brake tensioning wire 111 through a coupler 259. As the force is applied to the brake tensioning wire 111 through the coupler 259, a tension develops in the wire 111 and results in braking action on the bicycle 100, such as, for instance, through a tension wire actuated brake caliper 152 and 153 as described above.

Referring to FIG. 5, and with further reference to FIG. 4, a functional block diagram illustrates the transmitter 200 and the receiver 251 may include a security code setting system for setting a security code, e.g., a security number, as is well known in the art of wireless communications. The security system may include a security code setting unit 202, which may be an electrically erasable and programmable read only memory (EEPROM) (not shown) or a dip switch 202. The transmitter 200 also may include a switch 205, e.g., a “panic” operation switch, for initiating the braking action on a remote bicycle to which the receiving and control unit 250 is attached. A transmission microprocessor 220 may be provided and configured to perform, in response to output signal(s) from the switch 205, an arithmetic operation with respect to security code number data from a security code setting. As a result of the arithmetic operation, the microprocessor 220 outputs control signal(s) containing the security code data and braking instruction data that are transmitted from the transmitter 200 through the antennae 201 to the receiver 251 and received by the antennae 252 of the receiver 251.

The transmitter 200 may further include a modulator 221, which is provided to modulate control signals from the transmission microprocessor 220 at a carrier wave, as is well known in the art of wireless communications. A radio frequency (RF) amplifier 222 may be provided to amplify output signals from the modulator 221 to generate the radio signals to be transmitted to the receiver 251. The transmitting antenna 201 is adapted to transmit radio signals generated by the RF amplifier 222. A direct current (DC) power circuit 223 is provided to supply DC power from a DC power source 224 as operating power to the transmission microprocessor 220, modulator 221 and RF amplifier 222 in response to output signals from the switch 205.

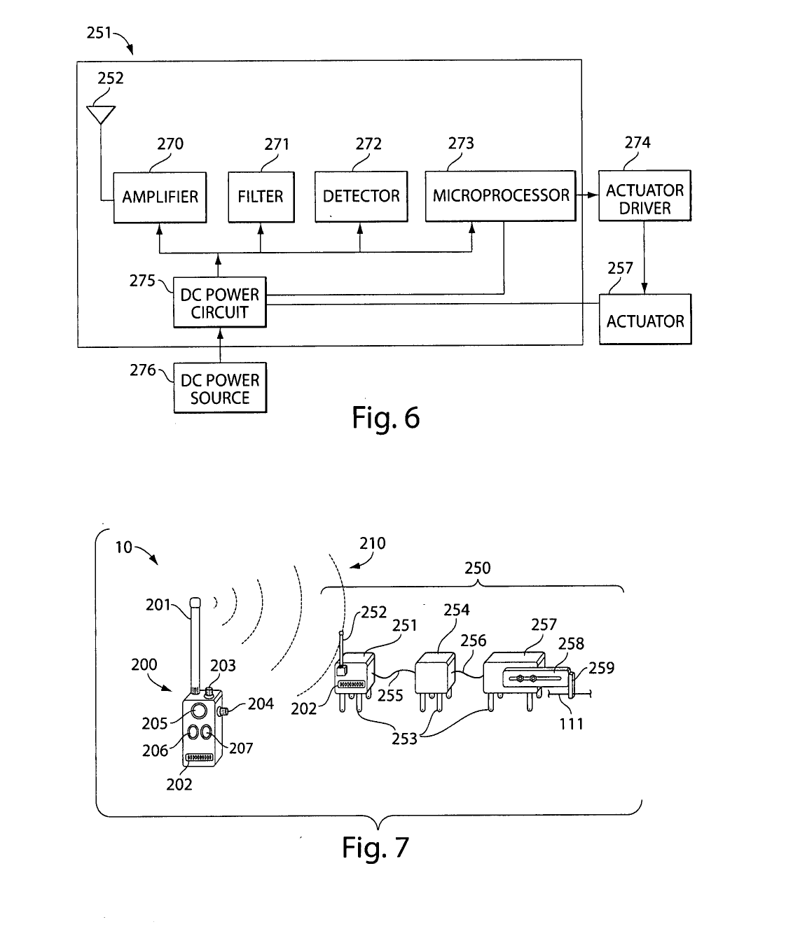

Referring to FIG. 6, and with further reference to FIG. 4, a functional block diagram illustrates the receiver 251 includes the receiving antenna 252 for receiving radio signals 210 transmitted through the transmitting antenna 201 of the transmitter 200, an amplifier 270 for amplifying radio signals received by the receiving antenna 252, a filter 271 for filtering output signals from the amplifier 270 to remove noise components therefrom, and a detector 272 for demodulating output signals from the filter 271 to detect control signals from the transmission microprocessor 220 of the transmitter 200. A reception microprocessor 273 is provided and is configured to receive control signals detected by the detector 272. The reception microprocessor 273 is configured to check whether the security code data contained in received control signal(s) is/are the same as pre-stored security code data and to generate control signal(s) in response to the data, if received control signal(s) is/are the same as the pre-stored security code data. Control signals from the microprocessor 273 are converted by an actuator driver 274 and delivered to the actuator 257, which applies the braking action to a bicycle. A direct current (DC) power circuit 275 is provided to supply DC power from a DC power source 276 as operating power to the amplifier 270, the filter 271, the detector 272, the microprocessor 273, the actuator driver 274, and the actuator 257.

Control of Braking Force/Pressure

Referring to FIG. 7, the remotely controlled brake actuator system 10 described above with reference to FIGS. 4-6 may further include additional controls and/or features. As shown in FIG. 7, the system 10 includes the transmitter 200 and the receiving and control unit 250. The transmitter 200 is configured for generating and transmitting command and/or control signals in the form of radio signals through the transmitting antenna 201 to the receiving and control unit 250, which is remotely mounted on a bicycle, e.g., through mounting straps 253. The receiving and control unit 250 is configured for receiving radio signals transmitted wirelessly by the transmitter 200. The transmitter 200 generates and transmits command and/or control signals to the receiving and control unit 250 in response to its actuation by, for instance, a person, e.g., a parent, supervisor or other guardian of an operator of the bicycle, who operates the transmitter 200. As will be described below, the transmitter 200 may be actuated to generate and transmit command and/or control signals through other devices and/or methods that generate and provide actuation inputs and/or signals to the transmitter 200 to actuate the transmitter 200 for operation.

As described above, the receiving and control unit 250 includes the receiver 251 with the receiving antenna 252 for receiving signals 210 transmitted from the transmitter 200. The receiving and control unit 250 is configured to process information from received signals 210, to generate instruction commands, and to apply predetermined pressures, tension, and/or other control mechanisms to a brake system of a bicycle.

As also described above, the transmitter 200 and the receiver 251 may include the security code setting system for setting a security code number, wherein the transmitter 200 and the receiver 251 may include the security code setting unit 202, which may be an electrically erasable and programmable read only memory (EEPROM) (not shown) or a dip switch 202. The transmitter 200 also may include a switch 205, e.g., a “panic” operation switch, for initiating the braking action on the remote bicycle to which the receiving and control unit 250 is attached without any adjustments.

As shown in FIG. 7, the transmitter 200 may further include a braking force adjustment selector switch 203 for setting the braking force/pressure of the braking tension, pressure, and/or other force to be applied to a bicycle braking system. The transmitter also may include a mode or form selector switch 204 for selecting the form of braking action, e.g., impulse, intermittent, continuous, audible, visual, or combination thereof, to allow the receiver 251 to apply at least one form of braking action of the braking force/pressure, which is set by the adjustment selector switch 203, to a bicycle braking system.

The transmitter 200 also may include a mode function switch 206 for setting the receiver 251 to output the form of braking action selected by the mode selector switch 204 for a period of radio transmission time, and a second function switch 207 for setting the transmitter 200 to output the selected form of braking action for a period of predetermined time, e.g. one second.

When the mode function switch 206 or the second function switch 207 are actuated, e.g., depressed, the selected form of braking action, e.g., impulse, intermittent, continuous, audible, visual, or any combination thereof, is implemented while the switch 206 or 207 is actuated. For instance, if the mode selector switch 204 were set to an “audible” braking action form, when the switch 206 or 207 is actuated, audible tone(s) would emanate from the transmitter 200 or the receiving and control unit 250 to provide an audible warning to the bicycle rider that braking action was imminent. In another instance, if the selected form of braking action were set to “impulse” form, when the switch 206 or 207 is actuated the system 10 would apply a rapid braking force, e.g., a quick tap, to the braking arrangement and thereby to the braking mechanism of the bicycle to provide a warning to the bicycle rider to slow or to stop the bicycle. This form of braking action is advantageous as a training tool in situations in which a person is teaching a child to ride a bicycle and would like to get the attention of the child riding the bicycle. However, for emergency situations, the “panic” switch 205, when actuated, is configured to apply braking force to a bicycle braking mechanism to fully engage the braking mechanism to help to completely stop the bicycle.

The transmission microprocessor 220 may be further configured to perform an arithmetic operation with respect to security code data from the security code setting, braking form data from the form adjustment selector switch 204 and braking action strength from braking force/pressure switch 203. In response to output signal(s) from a first and/or a second function switch 206 or 207, the transmission microprocessor 220 performs the arithmetic operation and outputs radio control signal(s) containing the security code data, braking form data and braking force/pressure data, as a result of the arithmetic operation. Output control signal(s) are transmitted through the transmitter antennae 210 to the receiver 251

As shown in FIG. 7, the receiver 251 receives via the receiving antenna 252 radio command and/or control signals 210 transmitted through the transmitting antenna 201. As described above, the receiver 251 also includes the reception microprocessor 273 configured to receive signals and to check whether the security code data contained in received signals are the same as the dip switch 202 selected value or pre-stored security code data. The reception microprocessor 273 generates control signals in response to the braking force/pressure data and the braking form data contained in received signals, if the security code data of the received control signals are the same as the dip switch 202 selected value or pre-stored security code data.

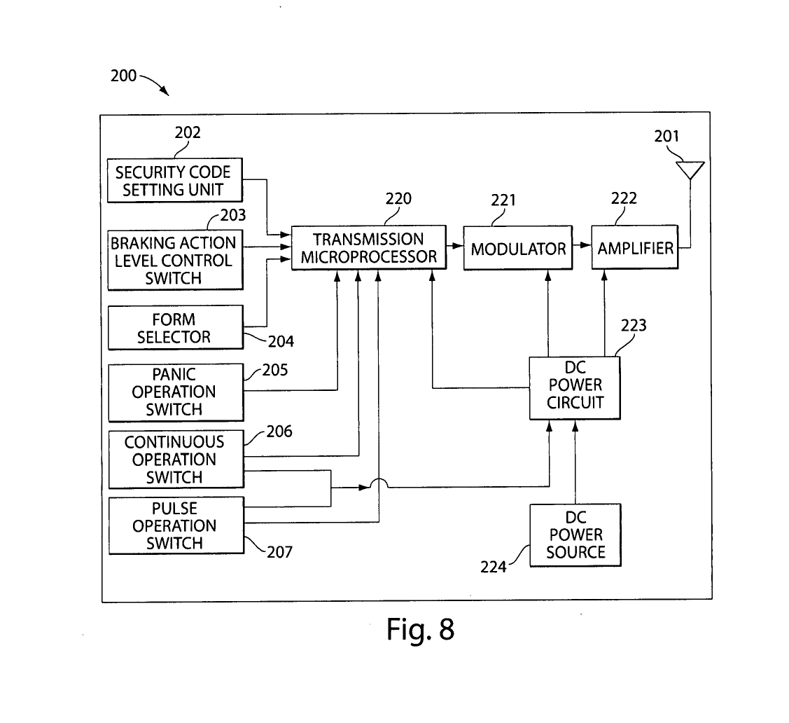

Referring to FIG. 8, a functional block diagram illustrates the transmitter 200 may include the security code setting unit 202 of the security code setting system, as described above, which is an electrically erasable and programmable read only memory (EEPROM) or dip switch, and may further include the braking force adjustment selector switch 203 for setting the braking force/pressure of a braking tension, pressure, and/or other force to be applied to a bicycle braking system. The transmitter 200 also may include the mode or form selector switch 204 for selecting a braking action form, e.g., impulse, intermittent, continuous, audible, visual, or combination thereof, to allow the receiver 251 to apply at least one form of braking action of the braking force/pressure, which is set by the adjustment selector switch 203, to a bicycle braking system.

The transmitter 200 may include the “panic” switch 205 for setting full braking action without further adjustments, as described above. The transmitter may further include the switch 206 for setting a period of radio transmission time, which may be about equal to the time the switch 206 is engaged, and the second function switch 207 for setting the transmitter 200 to output the selected form of braking action for a period of predetermined time, e.g., one second.

The transmission microprocessor 220 is configured to perform an arithmetic operation with respect to security code data from the security code setting, braking form data from the form adjustment selector switch 204 and braking force/pressure or strength data from the braking force adjustment selector switch 203 in response to output signals from one or more of the function switches 205, 206, or 207. As a result of the arithmetic operation, the microprocessor 220 generates control signal(s) containing the security code data, braking form data and braking force/pressure data.

The modulator 221 of the transmitter 200 modulates control signals from the transmission microprocessor 220 at a carrier wave, as is well known in the art of wireless communications. The RF amplifier 222 amplifies output control signals from the modulator 221 to generate radio signals for transmission to the receiver 251. The transmitting antenna 201 is adapted to transmit radio signals generated by the RF amplifier 222. The direct current (DC) power circuit 223 supplies DC power from the DC power source 224 as operating power to the transmission microprocessor 220, the modulator 221 and the RF amplifier 222 in response to output signals from one or more the function switches 205, 206, or 207.

Wireless Communication

Any number of wireless communications systems well known in the art may be used to transmit and process command and/or control data, including the desired or required braking control data, between the transmitter unit 200 and the receiver 250, such that the system 10 generates command and/or control signals wirelessly. As described above, the braking actuator system 10 according to the invention includes a radio frequency wireless communication system capable of operating at a range suitable for remote control of a bicycle braking system. The invention however is not limited in this respect and envisions any of a variety of wireless frequencies may be used. Common wireless control systems, such as those available from Futaba of Champaign, Ill., www.futaba-rc.com), operate in an approximate range of from about 70 to about 80 MHz and have a range of about 500 meters. Specific operating frequencies may depend on the available bands appropriated by a government regulating agency, such as the Federal Communications Commission (FCC) in the United States. For many applications of the invention, this range is suitable; however, for some designs longer ranges are desirable and may be achieved at numerous frequencies and power consumption.

Transmitter Designs

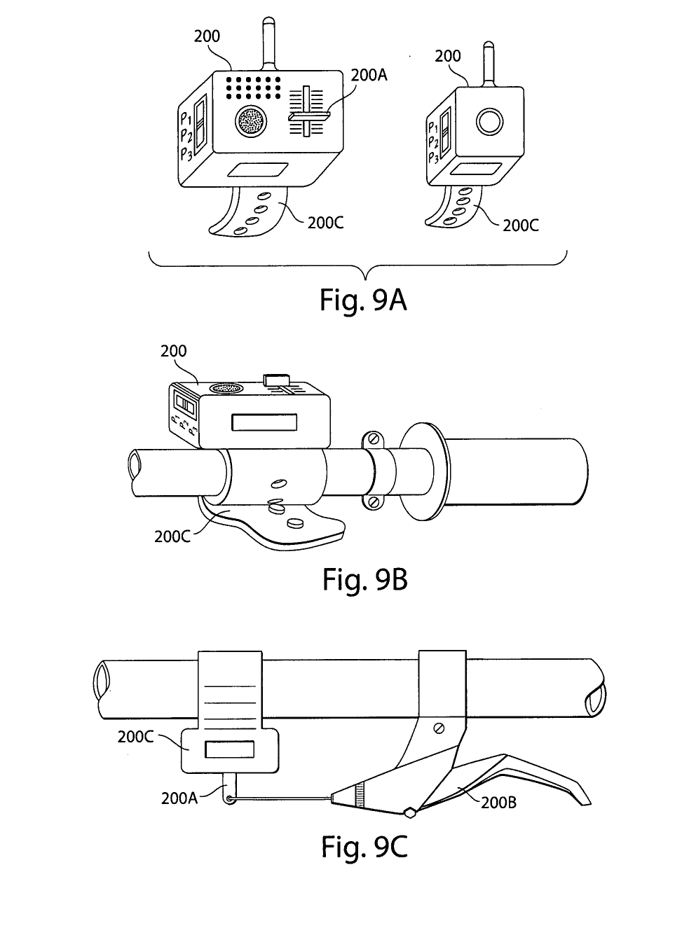

Various types and styles of transmitters 200 may be used. Handheld units, as shown in FIGS. 4 and 7, are one style of the transmitter 200 of the invention. Other transmitter designs configured to perform the functions of the system 10 according to the invention are possible. Other examples of the transmitter 200 are shown in FIGS. 9A-9C. FIGS. 9A and 9B show hand-held and/or strap-mounted transmitters 200 that may be mounted to a bicycle or other vehicle, as well as to a person's arm or wrist for convenient access via any type of fastening or connecting device 200C, e.g., straps. As shown in FIG. 9A, the transmitter 200 may be configured with a throttle switch 200A, e.g., a manually-actuated switch, that enables an end user or operator of the transmitter 200 to adjust the amount of the force/tension of the braking action the system 10 implements or actuates. FIG. 9B shows a handlebar mounted transmitter 200, and FIG. 9C shows a bar mounted transmitter 200, which may apply a similar braking action to a throttle switch 200A. The transmitter 200 shown in FIG. 9C may be mounted on a handlebar or a cross bar of a bicycle, e.g., to reduce possible confusion with the existing bicycle brake system, and may be mounted and configured to operatively connect with a hand-actuated lever 200B to enable the transmitter 200 to transmit control signal(s) that is/are proportional to an amount of force the hand-actuated lever 200B applies to the transmitter 200, e.g., via the throttle switch 200A, or to a distance of the lever 200B from the transmitter 200, when it is actuated. The resultant signal(s) emitted by the transmitter 200 will actuate the system 10 and thereby the bicycle brake mechanism with a force/tension proportional to the force applied on/by the hand-actuated lever 200B.

Initiation of Control Signals

The remotely controlled braking actuator system 10 according to the invention is not limited and may be actuated or initiated by a variety of methods and/or devices that generate and provide actuation inputs and/or signals to the transmitter 200 to actuate the transmitter 200 for operation. Described below are exemplary methods and/or devices for actuating or initiating the system 10.

Remote User Actuation of Braking Actuator System

The transmitter 200 may be actuated by a person, such as a parent observing a child riding a bicycle, who is located remotely from the bicycle. The person would actuate, e.g., push, a button, toggle or other actuator device the transmitter 200 incorporates to output command and/or control signals to initiate operation of the system 10. The resultant signals from the transmitter 200 are command and/or control signals sent wirelessly to the receiver 250 that is positioned on the bicycle in order to actuate the braking system of the bicycle, as described above.

Automatic Actuation of Braking Actuator System

1) Defined Physical Limits or Boundaries

Automatic braking may be initiated using the system 10 according to the invention in response to the system 10 receiving signals emanating from an external source, such as, for instance, a source disposed in the ground or at a certain physical limit or distance that may be defined, for instance, by a specified perimeter or boundary. For instance, a control line buried under the ground, similar to a pet fence design, may be operatively coupled with the transmitter 200 to generate signal(s) in response to detection of a bicycle crossing a defined area around the control line that actuates the transmitter 200 and the system 10 to cause automatic braking of the bicycle.

In another instance, the transmitter 200 may be actuated from signal(s) that emanate from a location at a certain distance from the transmitter 200 or a certain distance from a specified boundary or perimeter. The transmitter 200 may be located remotely from a bicycle on a fence or other boundary and may be configured to be set for a certain control distance, such as 50 feet, that would allow a child to ride their bicycle within 50 feet of the fence or other boundary. When the bicycle travels beyond the 50 foot area, the braking actuator system 10 actuates the braking mechanism of the bicycle. In one configuration, the transmitter 200 may be configured with a calibration device or other mechanism that permits calibration or adjustment of the control and/or the power of output signals from the transmitter 200. The transmitter 200 may constantly and/or intermittently transmit output signals to the receiving and control unit 250 mounted on a bicycle and such signals are received by the unit 250 as long as the bicycle is within a certain control distance and/or frequency range of transmission that the transmitter 200 and/or the unit 250 are configured or are programmed to operate such that when the bicycle and the unit 250 are outside such a distance and/or range, signal transmission ceases and as a result braking action is enabled to cause the bicycle to slow or to stop.

2) Predefined Distance from Second Bike

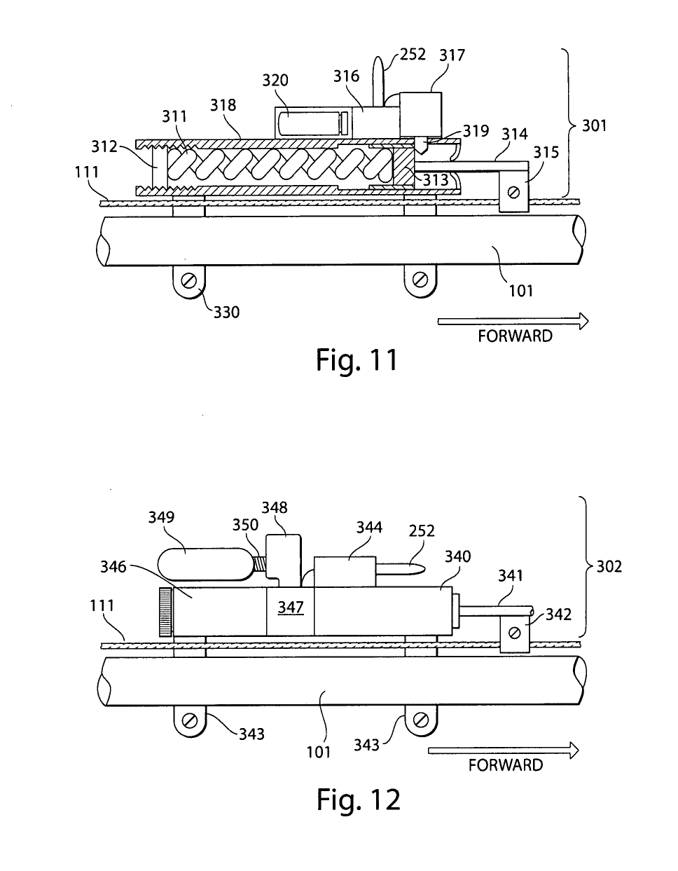

The system 10 may be configured such that the system 10 will initiate braking action when the transmitter 200 is separated from a braking arrangement, such as the braking arrangements 301, 302, 303, and 304 of the system 10 described below with reference to FIGS. 11-14 or other braking arrangements, of a bicycle by a predetermined distance. The system 10 may incorporate a control algorithm to first apply a small braking force upon detection of a first predetermined distance, and to apply progressively larger braking force as the separation distance detected between the transmitter 200 and the braking arrangement is increased. In this approach, the system 10 may help to enable a parent or guardian to keep a child, when riding a bicycle, from becoming separated by too great of a distance from the parent or guardian. In this context, the system 10 may be useful for a parent or guardian that is training a child to ride a bicycle and wants to ensure the child remains within an audible distance from the parent or guardian to hear the parent's or guardian's instructions.

3) Speed Threshold

Automatic actuation of the system 10 based on actual speed of a bicycle may not necessarily require the wireless transmitter 200 because the electronics control unit 254 may be enabled to determine speed of the bicycle and process speed information to send control signal(s) to the braking actuator 257. To determine the speed of a bicycle, any number of speed detectors may be used, including, but not limited to, GPS systems and magnetic rotation detectors.

4) Speed Control

The transmitter 200 or the bicycle mounted electronics control unit 254 may be set to a predetermined speed and the transmitter 200 will control the speed of the bicycle by applying or releasing the braking action of, for example, the caliper brake. Speed measurement systems for bicycles are well known in the art and may be employed here. For instance, GPS-based systems are common such as those manufactured by Garmin International, Inc. of Olathe, Kans. The caliper brake pad may be replaced by rollers to prevent excessive wear of the pads. A dial may be set on the transmitter 200, and depending on such setting and the actual speed of a bicycle, the control electronics 254 may apply a control algorithm, as is well known in the art of controls engineering, to determine if braking action should be increased or decreased, and may then send signal(s) as a result to the braking actuator 257 to increase or decrease the braking action, as required or desired.

5) GPS Control

A GPS receiver may be integrated with the control electronics unit 254 to enable a parent or guardian to program a “safe zone” such that braking action is initiated once a bicycle leaves the safe zone. A user may interface with computer based mapping software and may input acceptable streets and roads along which the operator of a bicycle is ‘authorized’ to access and/or may input restricted zones that are prohibited for bicycle riding. The software program would create a database of acceptable longitude and latitude values, and during operation, the control electronics 254 would compare data from the GPS receiver to that of the database of acceptable longitude and latitude and engage the braking system when the bicycle is no longer within the acceptable locations. To prevent a sudden stop of the bicycle, for instance, if the bicycle operator is crossing a busy road, the system 10 may be designed to first alert the operator of the impending braking action via audible tone and/or warning light. This warning zone will depend on the accuracy of the GPS receiver, but may be as little as several feet. Methods to implement such programming features are well known in the art of computer science.

Braking Arrangements—Tensioning/Actuation

The remote braking actuator system 10 according to the invention may incorporate a variety of braking arrangements depending on the specific energy source and an actuator driver selected to apply the braking force to a bicycle. For purposes of disclosure of an aspect of the invention, tension wire braking systems are described below. The invention is not limited in this respect and envisions the system 10 may incorporate any of a variety of other braking arrangements.

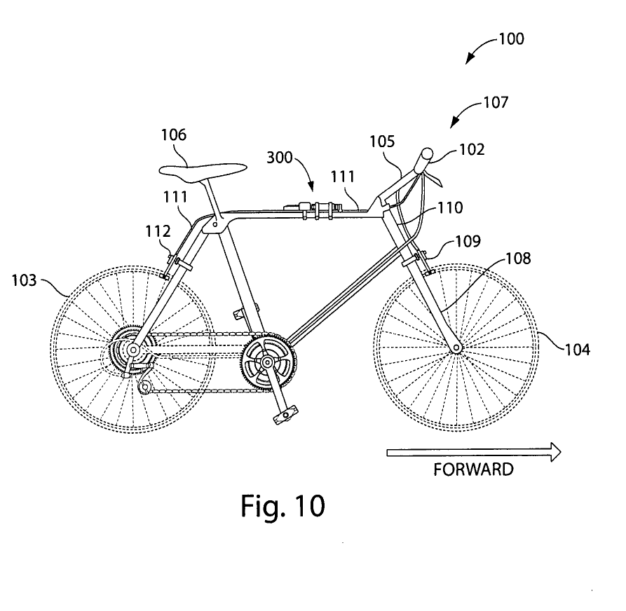

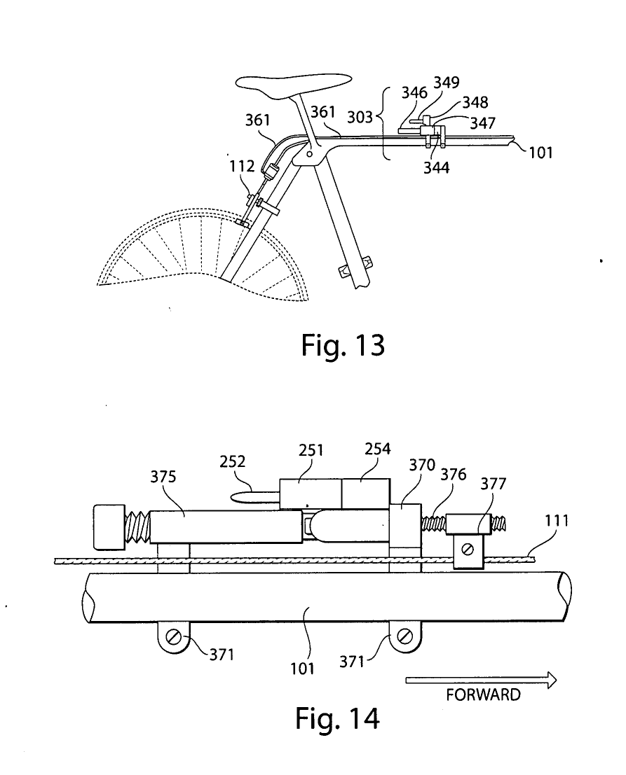

Referring to FIG. 10, an installation location 300 of any of the braking arrangements 301, 302, 303, and 304 shown in FIGS. 11-14 is illustrated on a prior art bicycle 100 of FIG. 1. Note, FIG. 13 includes electronic and energy storage components of FIG. 12 with an alternative installation location of a piston actuator.

The energy sources available to power an actuator driver may include, but are not limited to, electrical, pneumatic, hydraulic, mechanical, and other sources, as well as a combination thereof. An actuator that ultimately actuates the brakes, may include, but is not limited to, a solenoid, a pneumatically or hydraulically driven piston, an electrically driven linear motor, and a spring loaded piston.

1) Spring Actuated Braking Arrangement

The remote braking actuator system 10 according to the invention may incorporate a braking arrangement that employs a spring to create a tension in a brake tensioning wire. The spring is compressed and locked/latched and, when released, creates a tension on the tensioning wire. This design is simple and low cost to remotely and effectively stop a bicycle, for instance, in an emergency situation.

Referring to FIG. 11, the system 10 incorporates a braking arrangement 301 including a compression spring 311, an adjusting screw (not shown) that allows the compression of the spring 311 to be controlled, a spring plunger 313, and an extension arm 314 attached to the spring plunger 313. Fastener link 315 connects the piston arm 314 to the brake tensioning wire 111. A spring housing 318 is attached by fasteners 330 to a bicycle frame 101. Details of the fastener link 315 and assembly connection 330 and alternative configurations are discussed below. The receiver 251, the control electronics unit 254, and a DC power source 320 may be combined into a single unit 316, which is attached to the spring housing 318. The DC power source, shown in a cross sectional view of the housing 318, consists of a battery or battery pack 320, which is electrically connected to the receiver 251 and the control electronics unit 254 enclosed in the unit 316.

The receiver 251 and the control electronics unit 254 are electrically connected to a DC actuated solenoid 317. The solenoid 317 includes a spring-loaded solenoid plunger 319, which is designed to protrude down through a hole in the housing 318 in front of the spring plunger 313. The solenoid plunger 319 holds the compressed spring plunger 313 back until the solenoid 317 is actuated and the plunger 313 is retracted, thus maintaining the spring 311 in the compressed state. The invention is not limited to this arrangement and anticipates that other mechanical interconnections, linkages and systems may be used as are known in the art to retract and maintain the retracted spring 311.

The remote braking actuator system 10 incorporating the spring actuated braking arrangement 301 is designed to initiate braking of the bicycle 100 braking system when the transmitter 200 emits actuation control signal(s), e.g., as a result of actuation of the “panic” switch 205 of the transmitter 200 by an end user. The receiver 251 receives such control signal(s) from the transmitter 200, checks the signal(s) against a predefined security code and, if the security code matches, outputs signal(s) to complete a circuit between the battery 320 and the solenoid 317 that actuates the solenoid 317. The solenoid plunger 319 quickly retracts and allows the previously compressed spring 311 to push forward within the piston housing 318 with a force defined by the spring 311 and the setting of the adjusting screw 312. The forward motion of the spring 311 moves the piston arm 314 forward, as shown by the arrow of FIG. 12, and in a substantially parallel direction to the brake cable 111. This forward action puts tension on the brake tensioning wire 111 through the fastener 315 and actuates the bicycle 100 braking system to slow or to stop the bicycle 100, depending on the force of the spring.

After actuation of the spring loaded braking arrangement 301, the compression spring 311 may be manually reset. To accomplish this, the piston arm 314 is manually pushed into the spring housing 318 while, for instance, the transmitter switch 205 is actuated such that the solenoid plunger 319, which holds the spring 311, would be retracted in an “up” position and thus enable the spring 311 to be reset. In another configuration, the solenoid plunger 319 may be configured to permit it to be lifted up out of the way while the spring 311 is being reset. Alternatively, the spring plunger 313 may be physically designed to guide the solenoid plunger 319 without need of energizing the solenoid 317. After the spring 311 is compressed to the required position, the normally-extended solenoid 317 is moved into position to hold back the spring plunger 313. Once this is complete, the system 10 is enabled to slow or to stop a bicycle 100 remotely.

2) Pneumatic Piston Actuated Braking Arrangement—I

The braking system 10 according to the invention may incorporate a braking arrangement employing a pneumatic piston to create the desired or required tension in the brake tensioning wire 111. The pneumatic piston is connected to a source of high pressure gas, e.g., a CO2 cartridge, through a control valve. When desired or required, the valve may be partially or fully opened to allow gas to charge the pneumatic cylinder and to create a force which is transferred to the brake tensioning wire 111.

Referring to FIG. 12, the pneumatic braking arrangement 302 includes a pneumatic piston 340 with piston arm 341, and a fastener link 342 which connects the piston arm 341 to the brake tensioning wire 111 of the bicycle 100. The receiver 251 and the control electronics unit 254 may be combined into a single unit 344, which is attached to the pneumatic piston 340. The entire piston 340 with piston arm 341 and the receiver 251 and the control electronics unit 254 within the unit 344 are attached by fasteners 343 to the bicycle frame 101. Details of the fastener link 342 and assembly connection 343 and alternative embodiments are discussed below. The DC power source 346 includes a battery or battery pack, which is electrically connected to the receiver 251 and the control electronics unit 254 within the unit 344. The unit 344 is electrically connected to a DC actuated control valve 347. A regulator 348 designed to accept a portable 12 gram, 16 gram, or other compact CO2 cartridge is connected to the control valve 347. The CO2 cartridge 349 is connected to a regulator 348 through screw threads incorporated directly onto CO2 cartridge. Such compact CO2 cartridge 349 and regulator 348 are well known in the art.

Operation of the braking system 10 incorporating the pneumatic piston actuated braking arrangement 302 is initiated when the transmitter 200, disposed remotely from the bicycle 100, generates and transmits actuation signal(s) to the receiver 251 of the unit 344 mounted to the bicycle 100 in response to actuation of the transmitter 200, e.g., via a transmitter button 205 by an end-user and/or by other actuation inputs and/or signals from other devices and/or methods as described above. The receiver 251 receives the signal(s) and checks security code data the signal(s) represent against a predefined security code and, if the security code matches, outputs signal(s) to complete a circuit between the DC power source 346 and DC powered control valve 347 that causes the valve 347 to open. The valve 347 is configured such that it may actuate to a position, e.g., a fully-open position, to allow gas to escape from the CO2 cartridge 349 into the pneumatic piston 340 to increase the pressure of the piston 340 to a pressure that is defined by output(s) of the regulator 348. The increased piston 340 pressure forces the piston arm 341 out of the piston body and creates a force that is proportional to the piston gas pressure and the internal diameter of the piston 340. The forward motion, as shown by the arrow in FIG. 12, of the expanding piston 340 moves the piston arm 341 forward and in a substantially parallel direction to the brake tensioning wire 111. The forward action helps to put tension on the brake tensioning wire 111 through the fastener 342 and to actuate the bicycle 100 braking system to slow or to stop the bicycle 100, depending on the force of the piston or piston pressure.

In addition to operating in a “full-on” mode as a result of the valve 347 disposed in a fully-open position, such as may be required or desired for remote emergency operation of the bicycle 10 braking system, the pneumatic actuated braking arrangement 302 may be configured to create a tension that is controlled in force, depending on the desired or required level of braking force/pressure an end user selects or sets with the braking force adjustment selector switch 203 of the transmitter 200. A control circuit may be provided to amplify a variable control signal from the receiver microprocessor 273 to a variable voltage level that is proportional to the selected braking force/pressure selected or set with the switch 203. The variable voltage from the microprocessor 273 is sent to the control unit 344 via electrical connections, which actuates the control valve 347 to allow an amount of compressed gas from the CO2 cartridge 349 that is proportional to the variable voltage being applied from the microprocessor 273. The variable pressure applied by the control valve 347 is channeled to the pneumatic piston 340, which in turn actuates a piston cylinder (not shown) and moves the piston arm 341. The actuation of the piston cylinder pushes the piston arm 341 forward, as shown by the arrow in FIG. 12, substantially parallel to the brake line 111 and proportional to the control valve 347 actuation. The control valve 347 actuation is proportional to the receiver 251 signal(s), and is ultimately proportional to the setting on the switch 203, which has been remotely actuated or set at the transmitter 200 by the end user.

3) Pneumatic Piston Actuated Braking Arrangement—II

Referring to FIG. 13, an alternative braking arrangement 303 of the pneumatic piston actuated braking arrangement 302 described with reference to FIG. 12 is illustrated. The braking arrangement 303 is the same as the arrangement 302 of FIG. 12 with the exception of the location and type of pneumatic piston. The arrangement 303 of FIG. 13 replaces the piston 340 with a pneumatic piston 360 that is a spring-extended, reverse-acting piston 360. The piston 360 includes a piston arm 362 that extends in a non-energized state as a consequence of an internal spring. During operation of the arrangement 303, pressurized gas is fed to a front of the piston 360 to thereby force the piston arm into the piston cylinder. The control valve 347 includes a gas line from an output of the control valve 347 to a reverse acting port on the pneumatic piston 360. This braking arrangement 303 with the in-line installation of the reverse acting pneumatic piston 360 conveniently allows the normal operation of the operator actuated bicycle brake tensioning devices.

4) Electric Motor Actuation—Motor Linear Drive

The invention envisions other braking arrangements that employ an electric motor to create the required or desired tension to the bicycle brake tensioning wire 111. The remote brake actuator system 10 may incorporate a braking arrangement that includes an electric motor connected to a source of electrical power, such as a battery or battery pack, through electrical wiring and circuits. When required or desired, the electric motor is started and the motor rotates, moving a directly or indirectly coupled linear translation device. The rotation of the motor is controlled to create a force that is transferred to the bicycle brake tensioning wire 111.

Referring to FIG. 14, the system 10 incorporates an electric motor braking arrangement 304 including an electric motor 370, which is attached to the bicycle frame cross-member 101 by fasteners 371, the receiver 251 with the receiving antenna 252, the control electronics unit 254, and a DC power source 375, such as battery pack. Coupled to and protruding from the electric motor 370 is an actuator screw 376 that is threaded into a fastener 377, which has mating threads to the actuator screw 376. The fastener 377 is connected to an existing brake tensioning wire 111.

Operation of the electrically actuated remote braking actuator system 10 of the invention is similar to that described above with respect to the pneumatic braking system incorporating the pneumatic actuated braking arrangements 302 and 303 with the exception the battery pack power source 375 is used to energize the motor 370 and to move the fastener 377, rather than a pneumatic source actuating the pneumatic piston 340 and moving the fastener 342. When the transmitter 200 transmits signal(s) and such signal(s) are received by the receiver antenna 252, the receiver 251 converts such signal(s) into electronic data. Output(s) of electronic data by the receiver 251 are used in the control electronics unit 254 along with DC power from the battery pack 375 to actuate the motor 370. The actuated motor 370 turns the motor screw 376, and the turning of the motor screw 376, either clock-wise or counter clock-wise, pushes the brake-line fastener 377 forward to put tension on the brake tensioning wire 111, or backward to take off tension from the wire 111. If tension is exerted on the wire 111, such tension actuates the bicycle 100 braking system to slow or to stop the bicycle 100. If tension is taken off the wire 111, the bicycle 100 braking system is relaxed and the bicycle 100 can move.

5) Electric Motor Actuation—Under Seat-Mounted Motor

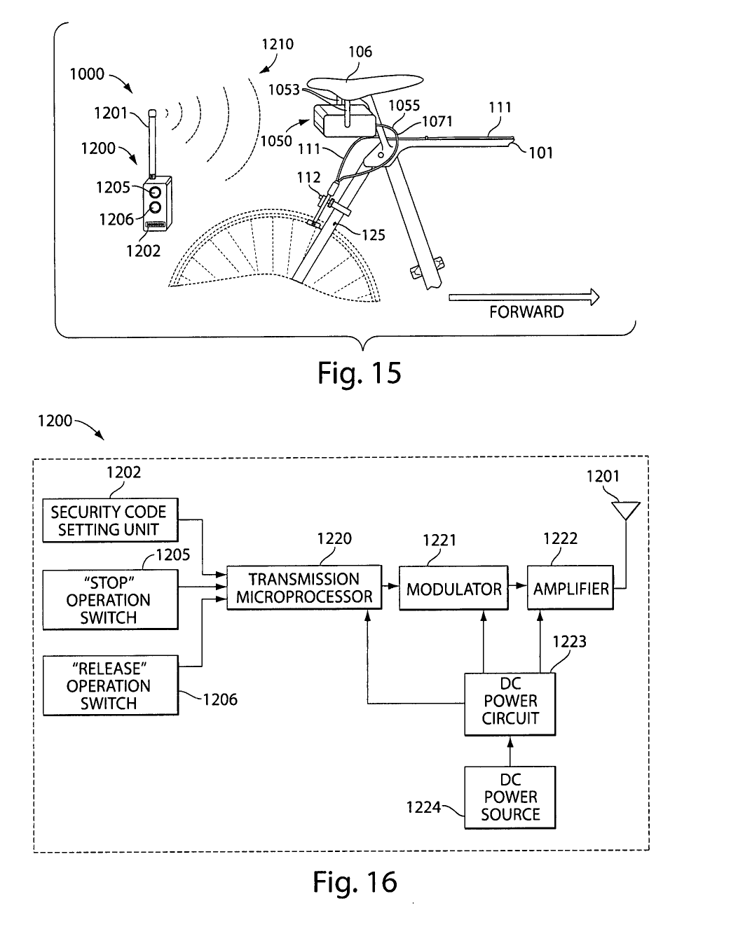

Referring to FIG. 15, in another aspect, the invention provides a remotely controlled brake actuator system 1000 according to the invention that includes a transmitter 1200 and a receiving and control unit 1050 that, when the system 1000 is deployed, is remotely located from the transmitter 1200 and is typically connected to a bicycle 100, e.g., connected to the bicycle 100 through one or more mounting straps 1053. The transmitter 1000 is configured for wirelessly transmitting command and/or control signals through actuation of the transmitter 1000 by a person, e.g., a parent, guardian or other supervisor of a person operating the bicycle 100. Such command and/or control signals are transmitted in the form of radio signals through a transmitting antenna 1201 and are received by the receiving and control unit 1050. The receiving and control unit 1050 is configured for receiving the radio signals transmitted by the transmitter 1200 through a receiver and antennae (not shown) that are disposed within the receiving and control unit 1050. The unit 1050 is further configured for processing information received from the radio signals, generating instruction commands, and applying a predetermined pressure, tension, or other control mechanism to a brake 112 of the bicycle 100, e.g., a rear caliper brake through a brake cable 1071. As shown in FIG. 15, the cable 1071 may be contained within a brake cable sheath 1055. The system 1000 and, in particular, the receiving and control unit 1050, is designed to be as compact as possible such that the system 1000 and/or the unit 1050 does not occupy a large volume or create excess weight and space that an operator of the bicycle 100 would need to handle. As shown in FIG. 15, the unit 1050 is mounted underneath a seat 106 of the bicycle 100.

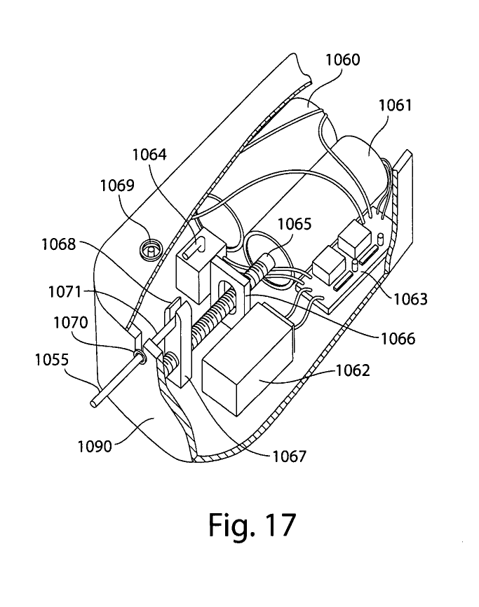

Referring to FIGS. 16 and 17, a functional block diagram of the wireless transmitter 1200 and a schematic cut-away view of the receiving and control unit 1050 are illustrated, respectively. The transmitter 1200 includes a security code setting unit 1202 for setting a security code, e.g., a security code number. The security code setting unit 1202 is an electrically erasable and programmable read only memory (EEPROM) or a dip switch 1202. The transmitter 1200 further includes selector switches, including a stop operation switch 1205, which is configured to help actuate forward action of a gear motor 1061 that causes tightening of the bicycle brake cable 1071, and a release operation switch 1206, which is configured to help actuate reverse action of the gear motor 1061 that causes loosening of the cable 1071. The transmitter 1200 includes a transmission microprocessor 1220 configured to perform an arithmetic operation with respect to security code data from a security code set with the unit 1202. The microprocessor 1220 performs the arithmetic operation in response to output signal(s) from the actuation of the stop operation switch 1205 or the release operation switch 1206. As a result of the arithmetic operation, the microprocessor 1220 outputs control signal(s) containing the security code data and the braking action data, e.g., motor forward action data or motor reverse action data.

The transmitter 1200 further includes a modulator 1221 which is provided to modulate control signal(s) from the transmission microprocessor 1220 at a carrier wave, as is well known in the art of wireless communications. The transmitter 1200 includes a radio frequency (RF) amplifier 1222 to amplify output signal(s) from the modulator 1221 to generate the radio signal(s) that are transmitted to the receiver (not shown) of the receiving and control unit 1050 through a receiving antenna 1064. The transmitting antenna 1201 is adapted to transmit the radio signal(s) generated by the RF amplifier 1222. A direct current (DC) power circuit 1223 is provided to supply DC power from a DC power source 1224 as operating power to the transmission microprocessor 1220, the modulator 1221 and the RF amplifier 1222 in response to output signals from the switches 1205 and/or 1206.

As shown in FIG. 17, the receiving and control unit 1050 includes a motor battery 1060, a gear motor 1061, a control electronics battery 1062, control electronics 1063, a radio signal receiver and antenna 1064, a drive rod 1065, a translation unit 1066 including a slide arm 1067, a brake cable attachment slot 1068, a recharging pin 1069, a cable sheath attachment sleeve 1070, and a brake cable 1071 housed within a cable sheath 1055, all of which are housed in a case 1090. The motor battery 1060, the gear motor 1061, the control electronics battery 1062, the control electronics 1063, the receiver 1064, and the recharging pin 1069 are operatively connected through a set of wires.

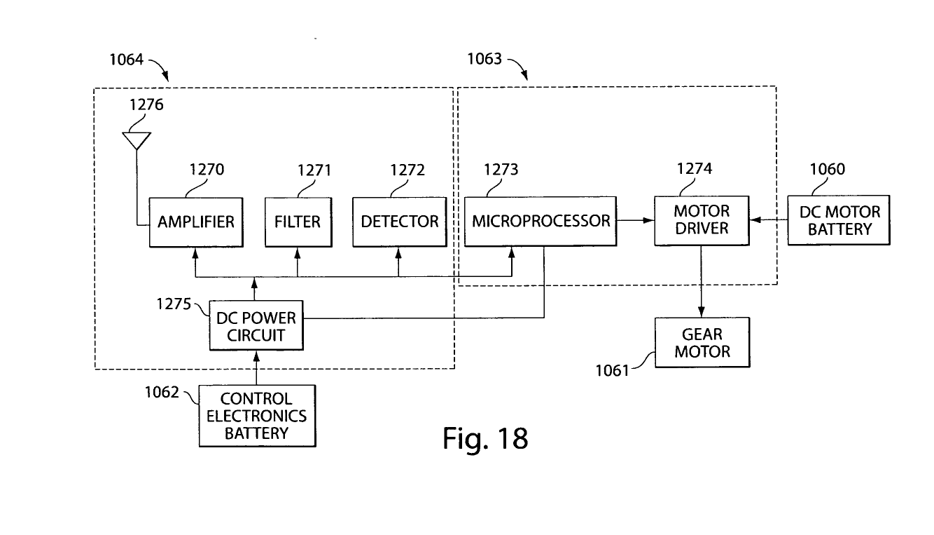

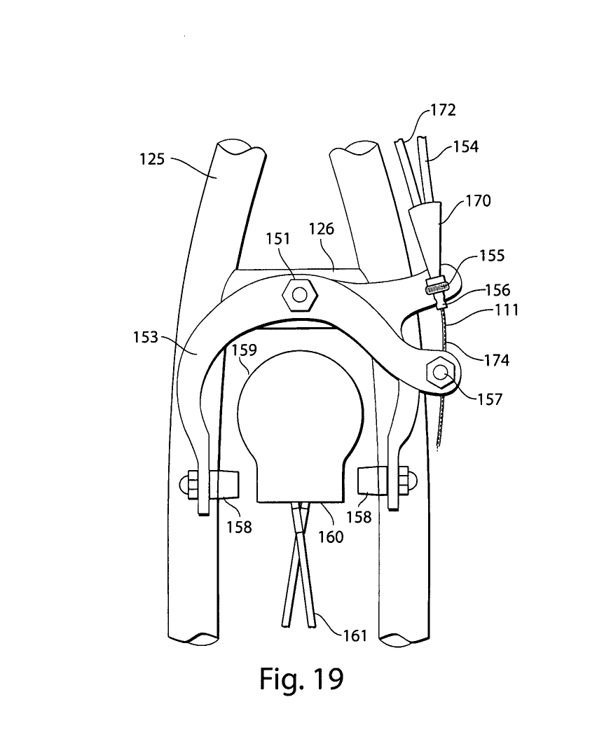

Referring to FIG. 18, a functional block diagram of the receiver and antenna unit 1064 and the control electronics unit 1063 is shown with the motor battery 1060, the gear motor 1061, and the control electronics battery 1062. The receiver 1064 includes a receiving antenna 1276 for receiving radio signals transmitted through the transmitting antenna 1201 of the transmitter 1200, an amplifier 1270 for amplifying the radio signals received by the receiving antenna 1276, a filter 1271 for filtering output signals from the amplifier 1270 to remove a noise component therefrom, and a detector 1272 for demodulating output signals from the filter 1271 to detect the control signals from the transmission microprocessor 1220 of the transmitter 1200 therefrom. Further, the control electronics unit 1063 includes a reception microprocessor 1273 that is provided to receive the control signal detected by the detector 1272, to check whether the security code data contained in the received control signal(s) is/are the same as pre-stored security code data, and to generate a control signal(s) in response to the data, if the received control signal(s) is/are the same as the pre-stored security code data. The control signal(s) from the microprocessor 1273 is/are converted by the motor driver 1274 to deliver power from the motor battery 1060 to the gear motor 1061. The gear motor 1061 forces the drive rod 1065 to turn forcing the slide arm 1067 to move linearly within the translation unit 1066 and to tighten the cable 1071 which applies tension to the caliper brake 112. The caliper brake 112 in turn applies the braking action to the bicycle 100 braking system. A direct current (DC) power circuit 1275 is provided to supply DC power from the control electronics battery 1062 as operating power to the amplifier 1270, the filter 1271, the detector 1272, and the microprocessor 1273. Due to potentially large current draws for the gear motor 1061, the actuator driver 1274, and the gear motor 1061 are connected to, and supplied current by, the DC motor battery 1060.

### EXAMPLE I

### Under Seat-Mounted Motor Actuated Brake System

Operation of the remote brake actuator system 1000 according to the invention is disclosed below in terms of a description of the construction and specifications of a prototype of the system 1000 including the receiver and control unit 1050 mounted below a seat of a child's bicycle.

The bicycle-mounted receiving and control unit 1050 is contained in a plastic reinforced nylon bag designed to mount under a seat of a bicycle. A schematic drawing of the bicycle-mounted unit 1050 is provide in FIG. 17. The bag is approximately 17 cm×10 cm×7.5 cm tall. Contained within the bag are a DC motor and a gear set, such as available within a Craftsman® cordless screwdriver, Model 911139, available from Sears® stores. The motor is approximately 27.5 mm in diameter and 1.5 inches long, operating with the 3.6 v NiCd rechargeable battery pack supplied in the Craftsman screwdriver at approximately 15,000 rpm. The coupled planetary gear set has a reduction of approximately 84:1, resulting in approximately 180 rpm output from the gear set (no-load). Speed reduction assemblies of the type used here are known to produce a corresponding increase in available spindle torque, as is well known in the art. The NiCd battery pack is a 3-cell unit with a typical 3.6 v output and is rated for 1400 mAhr.

The transmitter 1200 and the receiver 1064 are Rolling Code 2-channel UHF remote control units operating at about 433 MHz. The Rolling Code transmitter and receiver are available from Twin Industries Corporation, Los Gatos, Calif., (www.twinind.com), and are also available from Electronics123.com, Inc., of Columbiana, Ohio, www.electronics123.com. The system 1000 uses the 433 MHz transmitter 1200 and the receiver/control electronics 1063 and 1064 (using the Twin Industries units in which the control electronics and receiver were included on the same board) to control two relays, each rated for about 10 amps at 12 VDC, included with the control electronics. The transmitter 1200 has two control signal actuator buttons. Depressing an actuator button on the transmitter 1200 actuates the corresponding relay of the receiver 1050, and may be configured through a jumper style connector to operate in a toggle or momentary mode. The relays are set to operate in a momentary mode. The transmitter 1200 and receiver 1064 also include a rolling security code, as is known in the art of RF communications, and thus may operate securely.

As is commonly practiced in the art of DC motor control, the common leads of the relays were connected to one of the motor leads, while the normally closed connections were connected to the negative gear motor battery terminal (optionally grounded), and the normally open connections were connected to the positive gear motor battery terminal. The motor may operate in one direction when one of the relays is actuated, and in the opposite direction when the other relay is actuated, thus enabling the brakes to be driven in an engaged or disengaged direction.

The output shaft from the gear set is connected to a small linear translation device in order to convert the rotational force of the gear motor output shaft to a linear force capable of tensioning the brake cable. A modified rigid brand tubing cutter, such as Rigid catalog #40617 and Model #101, available from Close Quarters Cutter. The body of the tubing cutter is fixed to an aluminum plate, along with the gear motor. The cutting wheel is removed from the translating part of the cutter, and is thus free to couple with the brake cable end. The brake cable is connected to a 90 Degree bracket which is mounted to the aluminum mounting plate. This fixed the position of the brake cable sheath, which is required for proper use.

The output shaft of the gear motor is fixed through a mounting pin to the threaded bolt of the translation device; the threaded bolt has a pitch of approximately 8 threads per cm. Thus, one turn of the output shaft moves the translating part 1.25 mm and such movement is advantageous because the caliper brake would be fully engaged with approximately 1 to 6 mm of movement (depending on how far the brake pads are resting from the rim of the wheel, which may be readily adjusted).

During use, the system 10 and 1000 is able to stop a 40 Kg child riding a bicycle at a rate of over about 5 meters per second in less than about 10 meters.

Drive Shaft-Actuated Caliper Brake System

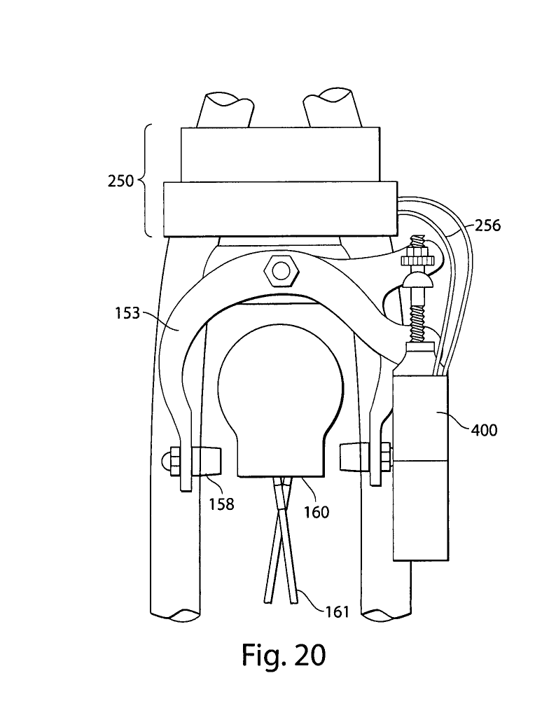

In a further aspect of the invention, the remote brake actuator system 10 and 1000 may be used with a caliper bicycle braking systems actuated by a drive shaft, as well as with bicycle braking systems actuated by a tensioning wire as described above. Referring to FIG. 20, a front view of a drive shaft-actuated, caliper bicycle brake mechanism is shown including a gear motor 400 attached to a drive shaft 401 and the receiver 251 and the control electronics 254 connected through wires 256. The caliper brake mechanism 153 shown in FIG. 20 is identical to the caliper brake mechanism of the prior art shown in FIG. 3 with the exception the tensioning wire 111 is replaced with a drive shaft 401 that adjusts the tension of the caliper brake by clock-wise or counter clock-wise movement of the gear motor 400. Tensioning of the caliper brake onto the rim of the rear tire 159 occurs when the gear motor 400 turns in the clock-wise direction, the threaded drive-shaft 401 turns inside the threaded bottom arm of the caliper brake 153, and the top arm of the caliper brake is forced upward as the drive shaft turns freely in the ball socket 402. Releasing the tension on the caliper brake 153 occurs when the gear motor 400 direction is reversed and the two arms of the caliper brake are pulled together. The speed and amount of braking force generated by the gear motor is partially due to the power of the gear motor 400 itself and also on the number of threads per inch on the threaded drive shaft 401. A small, high torque gear motor will allow this arrangement to be very responsive to operator control and also compact in size.

Electric Motors

Motors and gear-motors have been used to drive numerous items in consumer, industrial, and numerous other applications. As a result, they have undergone various improvements over past decades such as a reduction in manufacturing costs and associated inexpensive price, size reduction, higher torque output, higher efficiency, lower noise, longer service-life, to name a few. These motors exist in both AC and DC models that are designed to operate over a wide range of voltages, from fraction of a volt to hundreds and thousands of volts. The art of such motors is very well developed and numerous patents and other publications can be easily found.

Preferably, the motor is chosen to be compact in size, such that the overall system maintains a compact size to allow for convenient mounting and use. Because low-voltage, high torque, compact gear-motors are widely available, they are preferred for this application. However, any suitable drive can be used. Generally, there are two types of gear-motor designs: (a) a coupled type where the motor and gear set are produced independently, and then are coupled together to form the drive system, and (b) a unitary type where the motor and gear set are shared, forming a unitary drive system. Either type is suitable for the present invention.

Preferably, the electric motor is a gear motor that provides high torque and operates on DC power, as portable DC power sources, such as the common alkaline or rechargeable battery.

Braking Arrangement Connection

To allow normal operation of the operator-actuated brake tensioning devices, the braking arrangement is mounted to allow forward movement of the entire arrangement. This can be achieved, for example, by mounting with slotted-hole fasteners and adjusting such that the arrangement is stopped by the fasteners when the actuator is engaged. Thus, the system will be capable of applying a tension on the brake tensioning wire 111 when the actuator is allowed to extend. When the brake tension wire is pulled forward to create a tension on the brake mechanism, e.g., a brake caliper 112, the entire arrangement moves forward unimpeded that allows normal function of the brake mechanism.

Alternatively, or additionally, a limited slip type connector may be employed. The link to the tensioning wire 111 is designed such that forward movements in the tension wire are unimpeded.

A further alternative includes installing a separate brake tensioning wire to actuate the caliper type or other brake mechanism. The separately installed brake tensioning wire may be coupled to the existing brake tensioning wire 111 several cm before the connection to the caliper mechanism. Under this design, each tensioning wire would create braking force on the caliper or other brake mechanism when tensioned. The presence of the other brake tensioning wire would not create any significant impediments to operation.

And still a further alternative includes a separate brake mechanism may be installed that is completely independent of the operator actuated brake system.

In addition, the brake actuator system 10 and 1000 may be operated by the transmitter 200 and 1200, the receiving and control unit 250 and 1050 and any of the various brake arrangements described above, all of which are mounted to a bicycle and are operatively connected with the hand-actuated lever 200B as shown and described with reference to FIG. 9C to enable a rider of the bicycle to actuate the system 10 and 1000 via the lever 200B. The transmitter 200 and 1200 may be configured to control signal(s) that is/are proportional to an amount of force the hand-actuated lever 200B applies to the transmitter 200 and 1200, e.g., via the throttle switch 200A, or to a distance of the lever 200B from the transmitter 200 and 1200, when it is actuated. The resultant signal(s) emitted by the transmitter 200 and 1200 will actuate the system 10 and 1000 and thereby the bicycle brake mechanism with a force/tension proportional to the force applied on/by the hand-actuated lever 200B.

Alternative Brake Mechanisms

Many brake mechanisms exist in the art to transfer a braking action from an operator to the wheel, and each can be employed in this invention. Today, a majority of bicycles are equipped with caliper style brakes, such as single pivot caliper brakes, side-pull caliper brakes, center-pull caliper brakes, and dual-pivot caliper brakes, which are all well known in the art. Other common types of brake mechanisms known in the art include V-brakes, U-brakes, Delta brakes, and disc brakes. Most of these brakes share a common operating feature in that a tension line is used for actuation, as discussed earlier. As such, each may be easily adapted and employed in this invention. Furthermore, for systems that do not use a tension-wire type system, such as the hydraulically actuated disc brake, they too may be easily adapted to the current invention by coupling the output of the braking arrangement to the desired actuating system. For example, in a hydraulically actuated brake system, an electric motor may be designed to impart a force on a hydraulic unit to generate hydraulic pressure, thus actuating the brakes. Such a design to create hydraulic pressure may be learned from currently employed systems to transfer hand-operated brake pressure to hydraulic pressure as known in the art.

In the case that a bicycle is already equipped with an operator-actuated brake such as a caliper type brake, numerous alternatives can be employed. Two examples are provided below.

The first is a cable attachment that is connected to an existing caliper type brake that allows a tension cable from the typical handle-grip as well as a tension cable from the remote control braking arrangement to be connected to the caliper type brake. FIG. 19 shows a front view of a tension-wire actuated caliper-style brake mechanism including said cable attachment. This caliper brake is identical to the caliper brake of the prior art shown in FIG. 3, except for the connector 155 of FIG. 3 has been replaced with the cable attachment 170 in FIG. 19 which allows 2 tension wires to be connected. FIG. 19 shows that brake cable sheath 154 and 111 are connected as in the prior art, but now tension wire brake cable sheath 172 and wire 174 are also connected to the brake caliper. If either cable is tensioned, then the brake is actuated to stop or to slow the bicycle. The cable attachment 170 may also be designed such that two wires are connected to

[symbol]

Additional Elements or Features

Other elements or features of the invention are within the scope and spirit of the appended claims. For example, the brake arrangement 301, 302, 303, and 304 may include a device or system to measure the amount of tension imparted on or applied to the tension wire 111 during operation of the system 10 and 1000. Any of the brake arrangements described above, such as 301, 302, 303 and 304, may also include a device or system to measure the pressure on a pneumatic or hydraulic system or brake lines, depending on the configuration of the brake arrangement.

For use with a tensioning wire bicycle brake system, the system 10 and 1000 according to the invention may further include a load cell configured for load measurement that may be installed in the tensioning wire 111 to directly measure the tension imparted on or applied to the wire 111 at any time. Load cells are available in a variety of sizes, including subminiature sizes and may easily be incorporated into the system 10 and 1000. Output signals from a load cell may be fed via electrical wires to a monitoring circuit incorporated into the electronic control unit 254 and 374 of the braking arrangement 301, 302, 303, and 304 of the system 10 and into control unit 1063 of the motor-actuated braking arrangement incorporated in the unit 1050 of the system 1000. Braking force may therefore be adjusted to the actual desired or required braking force based on the load cell signal(s).

In another example, the system 10 and 1000 may be configured to actuate braking upon both bicycle wheels in response to the signal(s) from the system. To prevent the front wheel from locking and to reduce the likelihood of injury to an operator of the bicycle 100 when the front wheel locks, the system 10 and 1000 may be installed only on the rear wheel of the bicycle 100. In a further example, the receiver and control unit 250 and 1050 of the system 10 and 1000 may be further configured to brake both front and rear wheels of a bicycle 100 upon the signal(s) from the unit 250 and 1050 with the front wheel braking with less force/pressure than the rear wheel. One way of accomplishing this action may be with one or more load cells on each brake providing feedback to the control electronics 254 and 1063 to adjust pressure/force accordingly. The system 10 and 1000 would be configured to preferably cause the front wheel to brake from about 5% to about 95% less, more preferably from about 10% to about 50% less, and most preferably from about 10% to about 40% less braking action that applied to the rear wheel with such force/pressure adjustable.

As a further example, the system 10 and 1000 may be programmed to use an electronic lock for immobility of the bicycle. With the caliper brake described above, and the remotely controlled gear motor 1061 and tensioning device affixed to a bicycle, the remote control transmitter 200 may be used to tighten the caliper brake onto, for example, the rear wheel 104 of the bicycle 100. The end user or keeper of the transmitter 200 may walk away from the bicycle 100 with some assurance that the bicycle is inoperative because motion of the rear wheel 104 is restricted. When an operator of the bicycle desires to use the bicycle, the transmitter 200 is used to signal the tensioning device to release the caliper brake and thus once again enable the operation of the wheel.

As another example, with tensioning wire braking systems, any of the brake arrangements 301, 302, 303, ad 304, and others described herein, is capable of generating from about 1 to about 1000 N, and, more preferably, from about 1 to about 500 N (SI unit of Force), and even more preferably from about 1 to about 300 N.

In still a further example, to ensure that the system 10 and 1000 has a suitable level of battery power to operate, the control electronics unit 254 may include circuitry to determine the amount of charge remaining in the battery, or to determine other energy levels for non-electrical type designs, and cause the bicycle brake mechanism to engage, if the remaining charge falls below some predetermined threshold value. For example, the system 10 and 1000 may be set to a 20% threshold, such that when the circuitry determines that battery power is less than 20%, the system 10 and 1000 engages. Circuitry to determine the amount of remaining charge in a battery or battery pack is well known in the art of electrical engineering.

In yet another example, the system 10 and 1000 may operate with or without the transmitter 200 to apply braking action to the bicycle braking mechanism in a random or programmed manner. For instance, the transmitter 200 may be integrated into a console game device, such as the Sony Playstation® or Nintendo Wii®, to send braking control data to a stationary bicycle. The braking action may be caused to increase when there is a hill displayed on the viewing screen created by the game console by applying or releasing the braking action of, for instance, the caliper brake. To prevent excessive wear of the typical caliper brake pads of the prior art, the pads may be replaced by rollers. This braking action may be increased or decreased depending on the apparent slope of the incline. Further, the system 10 and 1000 may also include a feedback mechanism to provide apparent speed data to the control electronics 254 and 1063. Depending on the braking action level desired, the control electronics 254 and 1063 will apply a control algorithm, as is well known in the art of controls engineering, to determine if braking action should be increased or decreased, and may send signal(s) to any of the braking arrangements described above to increase or decrease the braking action, as required. In another instance, a randomly or predetermined braking action may be input into any of the braking arrangements described above to cause braking action to increase the resistance for the bicycle rider. This arrangement may be especially appealing to riders in flat terrain.

In another example, too prevent an operator of a bicycle from being surprised by the remotely controlled braking action implemented via the system 10 and 1000, and/or to train a bicycle rider, the system 10 and 1000 may be designed to first alert the operator of the impending braking action via audible tone and/or warning light. The warning may be for a predetermined amount of time, such as 10, 100, or 1000 or more milliseconds, before braking action is initiated. Further, the remote transmitter 200 may include a separate switch that causes only audible and/or visual indicators.

In a further example, the system 10 and 1000 also may be configured and arranged such that the system 10 and 1000 is directly mounted on a bicycle. This arrangement may provide an operator of the bicycle an ability to operate the bicycle brakes electronically. Such operation may be useful in a variety of situations, especially for off-road racing bicycles where an operator may dial-in a set braking level to control speed down a steep off-road incline. Such operation may also be useful for ‘trick’ bicycles where the front wheel is designed to rotate freely and traditional cables are not acceptable because they restrict movement.

Further examples include the system 10 and 1000 used with any of a variety of other wheeled vehicles, such as children's wheeled toys, children's wheeled vehicles, tricycles, roller blades, skate boards, roller stakes, scooters, mopeds, go-carts, and other wheeled sporting goods.

Various alterations, modifications and improvements to the above description will readily occur to those skilled in the art. Such alterations, modifications and improvements are within the scope and spirit of the invention. Due to the nature of software, processors, and computing devices, one skilled in the art will readily recognize that the invention may be embodied in hardwiring hardware, firmware, and/or software or combinations of any of these. Accordingly, the foregoing description is by way of example only and is not limiting. The invention's limit is defined only in the following claims and the equivalents thereto.

What is claimed is:

1. A remotely controlled braking actuator system for use with a braking mechanism of a wheeled vehicle, the system comprising:
a transmitter configured for wireless communication and further configured for actuation in response to one or more actuation signals;
a receiving and control unit operatively coupled with the transmitter and configured for wireless communication with the transmitter, the receiving and control unit being disposed remotely from the transmitter and mounted to the vehicle and being configured to respond to one or more control signals received from the transmitter; and
a braking arrangement operatively coupled with the receiving and control unit and mounted to the vehicle, the braking arrangement being disposed and being configured to implement a braking action of the braking mechanism of the vehicle,
wherein in response to one or more signals the receiving and control unit provides to the braking arrangement, the braking arrangement implements a braking action of the vehicle braking mechanism to slow or to stop the vehicle.

2. The system of claim 1, further including a switch disposed along the transmitter and operatively coupled with control electronics of the transmitter, the switch configured to provide, when activated, the one or more actuation signals to the transmitter.

3. The system of claim 1, wherein the one or more actuation signals emanate from a source external to the system, and wherein the source defines a boundary or a perimeter within which the vehicle is permitted to operate.

4. The system of claim 3, wherein the transmitter is configured for automatic actuation upon receipt of the one or more actuation signals which the source automatically transmits to the transmitter in response to detection of operation of the vehicle outside of the boundary or perimeter.

5. The system of claim 1, further comprising the transmitter including a security code setting unit programmed to set a security code value for enabling secure wireless communication to the receiving and control unit, and the receiving and control unit including a processor programmed to determine whether the security code value received from the transmitter matches the set security code value or a stored security code value.

6. The system of claim 5, further comprising the transmitter being configured with a braking force adjustment selector operatively coupled with control electronics of the transmitter, the braking force adjustment selector being configured to set a level of force or pressure of the braking action.

7. The system of claim 6, wherein the processor of the receiving and control unit being programmed to provide one or more signals to the braking arrangement to implement the level of force or pressure of the braking action, if the security code value received matches the set security code value or a stored security code value.

8. The system of claim 5, further comprising the transmitter being configured with a braking action form selector operatively coupled with control electronics of the transmitter, the braking action form selector being configured to set a form of braking action the braking arrangement implements, wherein the form of braking action includes at least one of: impulse, intermittent, and continuous braking action.

9. The system of claim 8, wherein the processor of the receiving and control unit being programmed to provide one or more signals to the braking arrangement to implement the form of braking action, if the security code value received matches the set security code value or a stored security code value.

10. The system of claim 8, further comprising the transmitter being configured with a form function switch operatively coupled with control electronics of the transmitter to set the processor to signal the braking arrangement to implement the form of braking action for a period of wireless transmission time.

11. The system of claim 8, further comprising the transmitter being configured with a second form function switch operatively coupled with control electronics of the transmitter to set the processor to signal the braking arrangement to implement the form of braking action for a period of time.

12. The system of claim 1, wherein the transmitter and the receiving and control unit being configured to operate wireless communication with a frequency range of from about 50 MHz to about 800 MHz.

13. The system of claim 1, wherein the braking arrangement includes an actuator operatively coupled with the processor of the receiving and control unit, the actuator being disposed and being configured to implement the braking action in response to receiving one or more signals from the processor.

14. The system of claim 13, wherein the actuator includes one of: (i) a spring-actuated actuator, (ii) a pneumatically-actuated actuator, and (iii) an electrical motor-actuated actuator.

15. The system of claim 13, wherein the braking action includes the actuator implementing the application of a force or tension to a tensioning wire of the vehicle braking mechanism.

16. The system of claim 15, wherein the actuator includes a linear actuator disposed and configured to generate a substantially linear force or tension, and wherein a linear translation component operatively connected with the linear actuator applies the linear force or tension to the tensioning wire.

17. The system of claim 1, wherein the braking arrangement includes a gear motor with a drive shaft mechanism operatively coupled to the processor of the receiving and control unit, the gear motor with the drive shaft mechanism being disposed and being configured to implement the braking action in response to receiving one or more signals received from the processor.

18. A remotely controlled, motorized braking actuator system for use with a braking mechanism of a wheeled vehicle, the system comprising:
a transmitter configured for wireless communication and further configured for actuation in response to one or more actuation signals;
a receiving and control unit operatively coupled with the transmitter and configured for wireless communication with the transmitter, the receiving and control unit being disposed remotely from the transmitter and mounted to the vehicle;
a processor disposed within the receiving and control unit and programmed to respond to one or more control signals received from the transmitter;
a motor driver disposed within the receiving and control unit and operatively coupled with the processor; and
a motor operatively coupled with the processor and the motor driver, the motor being disposed and being configured to cause a braking action of the braking mechanism of the vehicle,
wherein in response to one or more signals the processor provides to the motor driver, the motor driver powers the motor to implement a braking action of the vehicle braking mechanism to slow or to stop the vehicle.

19. The system of claim 18, wherein the one or more actuation signals emanate from a source external to the system, and wherein the source defines a boundary or a perimeter within which the vehicle is permitted to operate.

20. The system of claim 19, wherein the transmitter is configured for automatic actuation upon receipt of the one or more actuation signals which the source automatically transmits to the transmitter in response to detection of operation of the vehicle outside of the boundary or perimeter.

21. The system of claim 19, further comprising the transmitter including a security code setting unit programmed to set a security code value for enabling secure wireless communication to the receiving and control unit, and the processor being programmed to determine whether the security code value received from the transmitter matches the set security code value or a stored security code value.

22. The system of claim 21, further comprising the transmitter being configured with a braking force adjustment selector operatively coupled with control electronics of the transmitter, the braking force adjustment selector being configured to set a level of force or pressure of the braking action.

23. The system of claim 22, wherein the processor being programmed to provide one or more signals to the braking arrangement to implement the level of force or pressure of the braking action, if the security code value received matches the set security code value or a stored security code value.

24. The system of claim 21, further comprising the transmitter being configured with a braking action form selector operatively coupled with control electronics of the transmitter, the braking action form selector being configured to set a form of braking action the braking arrangement implements, wherein the form of braking action includes at least one of: impulse, intermittent, and continuous braking action.

25. The system of claim 24, wherein the processor being programmed to provide one or more signals to the braking arrangement to implement the form of braking action, if the security code value received matches the set security code value or a stored security code value.

26. The system of claim 1, wherein the braking action of the vehicle braking mechanism the motor implements includes the motor causing the tightening of a cable operatively connected to the motor that applies a force or tension to the vehicle braking mechanism.
